(19) United States
(12) Patent Application Publication
(10) Pub. No.: US 2026/0186869 A1
(43) Pub. Date: Jul. 2, 2026

(54) INTEGRATION OF EVENT AND AGGREGATED SUMMARY REPORTS FROM THE PRIVACY SANDBOX ATTRIBUTION REPORTING

(71) Applicant: Google LLC, Mountain View, CA (US)

(72) Inventors: Tong Geng, San Mateo, CA (US); Qing Zhang, Milpitas, CA (US); Fan Zhang, Sunnyvale, CA (US); Harikesh Sasikumar Nair, Palo Alto, CA (US); Adam Nicholas Smith, Mountain View, CA (US); Lijun Wang, West New York, NJ (US); Kapil Kumar, San Jose, CA (US); Qing Zhang, Sunnyvale, CA (US); Matthew William Dawson, Thousand Oaks, CA (US); Shengyu Zhu, Cupertino, CA (US); Bo Luan, Mountain View, CA (US); Nishanth Mundru, New York, NY (US); Fangzhou Sun, Mountain View, CA (US); Hao Chen, Mountain View, CA (US); Vikas Kumar Singh, San Ramon, CA (US); Chandan Giri, Menlo Park, CA (US)

(21) Appl. No.: 18/860,959

(22) PCT Filed: May 7, 2024
(86) PCT No.: PCT/US2024/028126

§ 371 Date: Oct. 28, 2024

Related U.S. Application Data
(60) Provisional application No. 63/513,809, filed on Jul. 14, 2023.

(51) Int. Cl. G06F 9/54; G06Q 30/0242

(52) U.S. Cl. CPC G06F 9/542; G06Q 30/0242

(57) ABSTRACT

The disclosure generally describes methods, software, and systems for interaction performance analysis. Aggregated summary reports including aggregated event-data collected are received, from application programming interfaces, by the application programming interfaces, during events corresponding to interactions with user interfaces. The aggregated event-data is aggregated using a hierarchical structure corresponding to a data type. A first portion of the aggregated event data identified as false positives is removed from the aggregated summary reports to maintain true positive aggregated event data. Noise is reduced from the true positive aggregated event data, at each level of the hierarchical structure, to generate denoised aggregated summary reports. Operations are determined using the denoised aggregated summary reports. An instruction to activate at least one of the operations using the denoised aggregated summary reports is provided, to an asset provider system.

### TECHNICAL FIELD

The present disclosure relates to computer-implemented methods, software, and systems for combining data from the event-level reports and the aggregated summary reports from the attribution reporting of application programming interfaces (APIs).

### BACKGROUND

Application programming interfaces (APIs) provide interfaces that can be used in computer applications to access other systems and associated functionality. In some instance, APIs can be used to collect and measure digital activity with respect to digital components provided by a platform (e.g., a content provider). However, interaction data (including advertisement data generated to indicate user activity, such as clicks, corresponding to presented advertisement) reported by the API can deviate from affirmative action data (conversion data), which in the context of digital components relates to performance of an action with respect to the digital component upon an initial interaction with the digital component. The deviations can be due to anonymization, aggregation, information truncation, and addition of noise. For example, the event-level reports can have statistical noise added, with attributed conversions that are truncated within pre-specified limits, reported only with limited conversion metadata over one-, two-, or three-time window(s).

### SUMMARY

Implementations of the present disclosure are directed to techniques and tools for interaction performance analysis. More particularly, implementations of the present disclosure are directed to integrating data from the event-level reports and the aggregated summary reports from the attribution reporting to provide measurements of interaction performance.

In some implementations, a method includes: receiving, from application programming interfaces, aggregated summary reports including aggregated event-data collected, by the application programming interfaces, during events corresponding to interactions with user interfaces, the aggregated event-data being aggregated using a hierarchical structure corresponding to a data type, removing a first portion of the aggregated event data identified as false positives from the aggregated summary reports to maintain true positive aggregated event data, reducing noise from the true positive aggregated event data, at each level of the hierarchical structure, to generate denoised aggregated summary reports, determining operations using the denoised aggregated summary reports, and providing, to an asset provider system, an instruction to activate at least one of the operations using the denoised aggregated summary reports.

The present disclosure also provides a computer-implemented system including: memory storing application programming interface (API) information, and a server performing operations including: receiving, from application programming interfaces, aggregated summary reports including aggregated event-data collected, by the application programming interfaces, during events corresponding to interactions with user interfaces, the aggregated event-data being aggregated using a hierarchical structure corresponding to a data type, removing a first portion of the aggregated event data identified as false positives from the aggregated summary reports to maintain true positive aggregated event data, reducing noise from the true positive aggregated event data, at each level of the hierarchical structure, to generate denoised aggregated summary reports, determining operations using the denoised aggregated summary reports, and providing, to an asset provider system, an instruction to activate at least one of the operations using the denoised aggregated summary reports.

The present disclosure also provides a non-transitory computer-readable media encoded with a computer program, the computer program including instructions that when executed by one or more computers cause the one or more computers to perform operations including: receiving, from application programming interfaces, aggregated summary reports including aggregated event-data collected, by the application programming interfaces, during events corresponding to interactions with user interfaces, the aggregated event-data being aggregated using a hierarchical structure corresponding to a data type, removing a first portion of the aggregated event data identified as false positives from the aggregated summary reports to maintain true positive aggregated event data, reducing noise from the true positive aggregated event data, at each level of the hierarchical structure, to generate denoised aggregated summary reports, determining operations using the denoised aggregated summary reports, and providing, to an asset provider system, an instruction to activate at least one of the operations using the denoised aggregated summary reports.

The foregoing and other implementations can each optionally include one or more of the following features, alone or in combination. In particular, implementations can include all the following features: The aggregated summary reports include hierarchically structured event-attributed configuration data as nodes distributed in a plurality of levels. Considering, the hierarchy of the aggregated summary reports weighted averages of parent nodes and child nodes can be generated to minimize a variance of an estimate of a parent node. The event-attributed configuration data include truncated aggregated as data slices at one or more levels. The noise includes Laplace noise added to each of the data slices. Processing the aggregated summary reports to reduce the noise includes: applying a denoising transformation to correct both for randomized response noising implemented by the Laplace noise and the truncated data. Applying the denoising transformation includes using a set of summary statistics that index aspects of a configuration type. The aggregated summary reports include metadata corresponding to the configuration type applied to the structured event-attributed configuration data.

Other implementations of the aspect include corresponding systems, apparatus, and computer programs, configured to perform the actions of the methods, encoded on computer storage devices.

The present disclosure also provides a computer-implemented method including: receiving, from application programming interfaces, event level reports including branches defining records of events including interactions with the application programming interfaces, the event level reports being paired with metadata corresponding to configurations of the application programming interfaces, performing an identification of portions of the metadata including invalid metadata, classifying a portion of the events as being on true branches by estimating a probability of each of the branches to be true or noised using the identification of the portions of the metadata that include the invalid metadata, determining configuration parameters for the true branches, the configuration parameters including a number of configurations on average for each event, generating raw application programming interface data by applying a debiasing model using the configuration parameters by joining a plurality of reporting windows and configuration types, determining operations using the raw application programming interface data, and providing, to an asset provider system, an instruction to activate at least one of the operations using the raw application programming interface data.

The present disclosure also provides a computer-implemented system including: memory storing application programming interface (API) information, and a server performing operations including: receiving, from application programming interfaces, event level reports including branches defining records of events including interactions with the application programming interfaces, the event level reports being paired with metadata corresponding to configurations of the application programming interfaces, performing an identification of portions of the metadata including invalid metadata, classifying a portion of the events as being on true branches by estimating a probability of each of the branches to be true or noised using the identification of the portions of the metadata that include the invalid metadata, determining configuration parameters for the true branches, the configuration parameters including a number of configurations on average for each event, generating raw application programming interface data by applying a debiasing model using the configuration parameters by joining a plurality of reporting windows and configuration types, determining operations using the raw application programming interface data, and providing, to an asset provider system, an instruction to activate at least one of the operations using the raw application programming interface data.

The present disclosure also provides a non-transitory computer-readable media encoded with a computer program, the computer program including instructions that when executed by one or more computers cause the one or more computers to perform operations including: receiving, from application programming interfaces, event level reports including branches defining records of events including interactions with the application programming interfaces, the event level reports being paired with metadata corresponding to configurations of the application programming interfaces, performing an identification of portions of the metadata including invalid metadata, classifying a portion of the events as being on true branches by estimating a probability of each of the branches to be true or noised using the identification of the portions of the metadata that include the invalid metadata, determining configuration parameters for the true branches, the configuration parameters including a number of configurations on average for each event, generating raw application programming interface data by applying a debiasing model using the configuration parameters by joining a plurality of reporting windows and configuration types, determining operations using the raw application programming interface data, and providing, to an asset provider system, an instruction to activate at least one of the operations using the raw application programming interface data.

The foregoing and other implementations can each optionally include one or more of the following features, alone or in combination. In particular, implementations can include all the following features: The configuration parameters include a configuration count of each configuration type and a configuration window. The computer-implemented method further including: determining truncated averages as an expected total configuration count of the each configuration type and window when being truncated for each configuration type. Determining truncated averages includes: determining total truncated averages by aligning an aggregate configuration count with the application programming interface data using impression dates, and determining sliced truncated averages by aligning a total aggregate configuration count with the application programming interface data using the impression dates and delay window levels. The total truncated averages include a total configuration count truncated at a number of configurations. The total truncated averages include corner cases that are absent from event simulations and appear in the total aggregate configuration count. The sliced truncated averages include truncation ratios per data slice. Estimating the probability of each of the branches to be true or noised includes generating a ratio of total interactions count on an impression date obtained from interaction logs relative to total number of conditioning interactions.

The present disclosure also provides a computer-implemented method including: receiving, from application programming interfaces, event level reports including a biased record of events including interactions with the application programming interfaces, the event level reports being paired with metadata corresponding to configurations applied by application programming interfaces, generating raw event level reports from the event level reports by applying a debiasing model using configuration parameters of the application programming interfaces to remove false events from the event level reports, receiving, from the application programming interfaces, aggregated summary reports including an aggregated record of the events corresponding to the interactions with the application programming interfaces included in the event level reports, generating raw aggregated summary reports from the aggregated summary reports by using metadata mapping to remove false positives events from the event level reports, generating statistical data by matching the raw event level reports to the raw aggregated summary reports according to event scenarios, determining operations using the statistical data, and providing, to an asset provider system, an instruction to activate at least one of the operations using the statistical data.

The present disclosure also provides a computer-implemented system including: memory storing application programming interface (API) information, and a server performing operations including: receiving, from application programming interfaces, event level reports including a biased record of events including interactions with the application programming interfaces, the event level reports being paired with metadata corresponding to configurations applied by application programming interfaces, generating raw event level reports from the event level reports by applying a debiasing model using configuration parameters of the application programming interfaces to remove false events from the event level reports, receiving, from the application programming interfaces, aggregated summary reports including an aggregated record of the events corresponding to the interactions with the application programming interfaces included in the event level reports, generating raw aggregated summary reports from the aggregated summary reports by using metadata mapping to remove false positives events from the event level reports, generating statistical data by matching the raw event level reports to the raw aggregated summary reports according to event scenarios, determining operations using the statistical data, and providing, to an asset provider system, an instruction to activate at least one of the operations using the statistical data.

The present disclosure also provides a non-transitory computer-readable media encoded with a computer program, the computer program including instructions that when executed by one or more computers cause the one or more computers to perform operations including: receiving, from application programming interfaces, event level reports including a biased record of events including interactions with the application programming interfaces, the event level reports being paired with metadata corresponding to configurations applied by application programming interfaces, generating raw event level reports from the event level reports by applying a debiasing model using configuration parameters of the application programming interfaces to remove false events from the event level reports, receiving, from the application programming interfaces, aggregated summary reports including an aggregated record of the events corresponding to the interactions with the application programming interfaces included in the event level reports, generating raw aggregated summary reports from the aggregated summary reports by using metadata mapping to remove false positives events from the event level reports, generating statistical data by matching the raw event level reports to the raw aggregated summary reports according to event scenarios, determining operations using the statistical data, and providing, to an asset provider system, an instruction to activate at least one of the operations using the statistical data.

The foregoing and other implementations can each optionally include one or more of the following features, alone or in combination. In particular, implementations can include all the following features: The biased record of events includes anonymization, aggregation, information truncation and noise infusion to interaction data to protect a privacy of users performing the interactions with the application programming interfaces. The aggregated summary reports include hierarchically structured event-attributed configuration data as nodes distributed in a plurality of levels and the event-attributed configuration data include truncated configurations aggregated as data slices at one or more levels. The hierarchy of aggregated summary reports can be used to generate weighted averages of parents and children to minimize a variance of an estimate of a parent node The noise includes Laplace noise added to each of the data slices. Post-processing the raw aggregate summary reports data includes two steps: remove false positives in the data, and take advantage of the hierarchy to reduce the noise. Processing the raw aggregated summary reports to reduce the noise includes: applying a denoising transformation to correct both for randomized response noising implemented by the Laplace noise and the truncated configurations. The denoising transformation uses a set of summary statistics that index aspects of the configuration type. The aggregated summary reports include metadata corresponding to a configuration type applied to the structured event-attributed configuration data. The configuration parameters include a configuration count of each configuration type and a configuration window. The computer-implemented method further includes determining truncated averages as an expected total configuration count of the each configuration type and window when being truncated for configurations. Determining truncated averages includes: determining total truncated averages by aligning an aggregate configuration count with the application programming interface data, and determining sliced truncated averages by aligning a total aggregate configuration count with the application programming interface data. The total truncated averages include a total configuration count truncated at a number of configurations. The total truncated averages include corner cases. The sliced truncated averages include truncation ratios per data slice. Estimating the probability of each of the branches to be true or noised includes generating a ratio of total interactions count on an impression date obtained from interaction logs relative to total number of conditioning interactions.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Particular embodiments of the subject matter described in this specification can be implemented to realize one or more of the following advantages. The techniques described in this specification provide, protection of user data privacy and security. Adaptation of data processing to multiple types of API configurations can enable flexibility of technology integration. The generation of statistical data including interaction measurements and consumption of the statistical data can be faster than in convention systems, in which separate different protocols are applied. The generation of statistical data by merging event-level data and aggregated summary reports increases an accuracy of the interaction measurements, by leveraging the combined use of the API data that provides better measurement fidelity than using either report type in isolation. The merging of event-level data and aggregated summary reports can be supported and optimizing using machine learning models built to optimize an interaction measurement derivation process. Along with the interaction, the API returns some information about any conversions that may (or may not) have happened within a predefined duration after the interaction. A canonical use-case for the event-level reports can include model training. The trained information can be used to predict conversions, conversion rates or conversion values, conditional on the features of an interaction. Predicting conversions is a key input to automated bidding models because it serves as a (stochastic) signal to the bidding algorithm which events are likely to lead to conversion acceptable to a content provider. The bidding algorithm decides on its bid algorithmically by taking the interaction as an input, so the quality of the model prediction in turn affects the quality of the bidding optimization directly. To protect user privacy, the API does not return the event-level data with full fidelity. Rather, a small proportion of interactions are randomly chosen by the browser/platform to be assigned random conversion metadata. In addition, there are limits on how much metadata can be extracted from the conversions.

Other advantages of the described implementations are associated to eventification, which refers to the process of extracting event-level affirmative action data from the event-level reports and from the aggregated summary reports. One advantage of eventification is that even though utilizing a different measurement technology altogether, the eventified log is similar in structure to the event-level data recorded by third party cookies. The structure similarity facilitates the insertion of the eventified log into existing data pipelines and other modeling infrastructure. The compatibility of the eventified log with existing data pipelines optimizes the use of computing resources, by reducing the technical debt, facilitating the transition to systems including ARA API. Another advantage of eventification is that the same eventified log can be used for many use-cases, including top ranked (one or two) dominant use-cases of reporting and bidding. For reporting, the eventified log can be aggregated as appropriate to the slice for which reporting is used, for example at the campaign level. For bidding, eventification facilitates training of machine learning models using conversions (or conversion values) as labels and with interaction-event characteristics as features. The training of machine learning models uses as input a training dataset with units of interaction-events and attributed conversion (or conversion values) combinations, matching the structure of the eventified logs. Building both the reporting and the bidding off the same log can reduce processing complexity and automatically provides consistency across use-cases.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system that can be used to execute implementations of the present disclosure.

FIG. 2A is a block diagram of another example system, according to some implementations of the present disclosure.

FIG. 2B is a block diagram of data flow within the example system of FIG. 2A, according to some implementations of the present disclosure.

FIG. 3 a flowchart of an example denoising process, according to some implementations of the present disclosure.

FIG. 4A is an example aggregated summary report, according to some implementations of the present disclosure.

FIG. 4B is an example aggregated summary report data, according to some implementations of the present disclosure.

FIG. 4C is an example denoised aggregated summary report, according to some implementations of the present disclosure.

FIG. 5 a flowchart of an example debiasing process, according to some implementations of the present disclosure.

FIG. 6A is an example raw event level data, according to some implementations of the present disclosure.

FIG. 6B is an example event application programing interface data, according to some implementations of the present disclosure.

FIG. 7A is a diagram of an example event branch classification, according to some implementations of the present disclosure.

FIG. 7B is a diagram of example conversions based on event branch classification, according to some implementations of the present disclosure.

FIG. 8 a flowchart of an example process, according to some implementations of the present disclosure

FIG. 9 is a diagram of example probability estimates, according to some implementations of the present disclosure.

FIG. 10A is a diagram of example fake probability estimates, according to some implementations of the present disclosure.

FIG. 10B is a diagram of example joining truncated data, according to some implementations of the present disclosure.

FIG. 10C is a diagram of example joining truncated average data, according to some implementations of the present disclosure.

FIG. 11A is an example of affirmative action data, according to some implementations of the present disclosure.

FIG. 11B is an example of event level report data, according to some implementations of the present disclosure.

FIG. 11C is an example of eventified log after event denoising data, according to some implementations of the present disclosure.

FIG. 11D is an example of event level application programing interface output data, according to some implementations of the present disclosure.

FIG. 11E is an example of debiased event level application programing interface result data, according to some implementations of the present disclosure.

FIG. 11F is an example of probability estimates on fake branches, according to some implementations of the present disclosure.

Like reference numbers and designations in the various drawings indicate like elements.

### DETAILED DESCRIPTION

Implementations of the present disclosure are directed to techniques and tools for interaction performance analysis. More particularly, implementations of the present disclosure are directed to integrating data from the event-level reports and the aggregated summary reports from attribution reporting to provide measurements of interaction performance. The event level reports include filtered interaction event data corresponding to interaction-events generated according to multiple conversion types that can be reported in a truncated format. Event level reports are received from application programming interfaces (APIs) of different source system that can have different ways to expose metadata corresponding to APIs and events. The aggregated summary reports include data aggregates generated by grouping event-attributed affirmative action data that is aggregated to a slice level. The aggregated summary reports are configured based on a pre-definition of the slices, over which an interaction provider system plans to learn about conversion activity. The event-level and aggregated summary reports represent two different views of the same underlying interaction data. The nature of the data generated by both is a function of how each transforms the same underlying data to preserve user privacy. The described process includes a derivation of user interaction measurement based on applied data privacy transformations. For example, the described technology considers two aspects of working with the API data: conversion truncation and noise considerations, and how these aspects differ for each of the API, according to respective configurations. The term “event” in event-level reports corresponds to interaction-events. That is, the event-level reports include a report with a granularity defined by an interaction, such as a click or a view.

Gathering interaction information from API reports is cumbersome because of the deviations. The deviations can be due to, e.g., anonymization, aggregation, information truncation and addition of noise. For example, the event-level reports can have statistical noise added, with attributed conversions that are truncated within pre-specified limits, reported only with limited conversion metadata over one, two or three time window(s). The event level reports include the deviations as a biased record of events indicative of interactions with user interfaces, the records of events being biased to preserve security and privacy of user data. The event level reports can be paired with metadata corresponding to API configurations. The event level reports can be configured according to corresponding API configurations. The configured event level reports can be processed to generate raw event level reports from the configured event level reports by applying a debiasing model using configuration parameters of the application programming interfaces to reduce (or remove) false events from the event level reports.

In addition to generating event level reports, APIs can also generate aggregated summary reports including event-attributed configuration data. The event level reports can be configured according to corresponding API configurations, as configured aggregated summary reports. The configured aggregated summary reports can be processed, by using metadata mapping, to remove false positives events from the event level reports to generate raw aggregated summary reports. The raw event level reports are matched to the raw aggregated summary reports according to event scenarios (defining interaction data deviation strategies, such as truncation processes) to generate statistical data. The statistical data can be used to determine one or more matching operations that can be filtered and ranked according to set selection criteria to provide, to an asset provider system, an instruction to activate at least one of the operations using the statistical event-attributed data.

As interaction monitoring systems (e.g., advertising ecosystems) make a significant pivot towards improved ways of protecting user privacy, the use of privacy-enhancing technologies (PETs), such as the attribution reporting (ARA) API, can increasingly become relevant for interaction measurement. Measurement-focused PETs can facilitate interaction measurement while protecting user's cross-site and cross-application identities from being revealed to interaction service provider systems, such as content provider systems, service providers (e.g., advertisers), publishers and other entities (henceforth, collectively referred to under the umbrella-term “content provider systems”). The specificities of data privacy implementations can include one or more differences and at least one common feature. A common feature of PETs is to limit the information content of campaign performance data, by leveraging some combination of anonymization, aggregation, information truncation, and noise infusion to the data before it is released, by a secure distribution system, to asset provider systems and/or content provider systems. The common feature of PET processes can provide privacy guarantees while continuing to support service (e.g., testing or advertising) use-cases in a sustainable way.

The system and processes described in the current disclosure present technologies for derivation of statistical data that can be used by content provider systems and/or asset provider systems consuming the interaction data and utilizing the statistical data for operations related to various interaction use-cases. The described technologies for derivation of statistical data address several new data and modeling-related issues that were previously not present with third-party cookies (3PC). The issues arise from the changes introduced by the API data for protecting user data privacy. Due to anonymization, aggregation, information truncation and addition of noise, the data reported to content provider systems by the API can deviate from the affirmative action data measured by 3PCs (henceforth 3PC conversions). For ARA, the event-level reports can have statistical noise added; with attributed conversions that are truncated within pre-specified limits; reported only with limited conversion metadata over one-, two- or three-time window(s). The summary reports that can be obtained from the aggregated summary reports can be reported at the aggregate slice level, can have statistical noise added, and can have conversions that are truncated within pre-set limits. The described system enables the content provider systems and/or asset provider systems to consume ARA data (event-level reports and summary reports) received from the API and processed to generate statistical data that can be used for service (e.g., testing or advertising) use-cases.

Addressing the limitations of API data deviations, the integration protocol described in the present disclosure enables bundling of resources across different protocols, without the use of third-party cookies. A control of user privacy and system security can fail if third-party cookies are used. For example, third-party tracking requests can intentionally block their own referring URL using nested scripts to avoid detection for user interaction data tracking. In contrast to third-party user interaction data tracking, the described implementations present user interaction data tracking as aggregated summaries and as event level reports generated by an API. The configuration settings of the API can be designed to protect user privacy and enable control of system security. Another advantage of the described implementations is that even though API based user interaction data tracking utilize a different measurement technology altogether, the generated reports can be similar in structure to the user interaction data recorded by third party cookies. The structural similarity facilitates the insertion of the eventified log into existing data pipelines and other modeling infrastructure built for third-party cookies data with little changes while still protecting user privacy and system security. The integration protocol described in the present disclosure includes a set of methodologies, by which the data from the event-level and aggregated summary reports can be merged together to facilitate interaction-measurement with high utility. The described process of combining and merging the data sets can provide as to how the API can be utilized for improving service (e.g., advertising) measurement.

In addition to the preservation of user data privacy and security, interaction-measurement protocol described in the present disclosure can also provide an adaptation of data processing to multiple types of API configurations that can enable flexibility of technology integration. As another technical advantage of the described technology, the generation of statistical data including interaction measurements and consumption of the statistical data can be faster than in convention systems, in which separate different protocols are applied. The generation of statistical data by merging event-level data and aggregated summary reports increases an accuracy of the interaction measurements, by leveraging the combined use of the API data that provides better measurement fidelity than using either report type in isolation. The merging of event-level data and aggregated summary reports can be supported and optimizing using machine learning models built to optimize an interaction measurement derivation process. Along with the interaction, the API returns some information about any conversions that may (or may not) have happened within a predefined duration after the interaction. A canonical use-case for the event-level reports can include model training. The trained information can be used to predict conversions, conversion rates or conversion values, conditional on the features of an interaction. Predicting conversions is a key input to automated bidding models because it serves as a (stochastic) signal to the bidding algorithm which events are likely to lead to conversion acceptable to a content provider. The bidding algorithm decides on its bid algorithmically by taking the interaction as an input, so the quality of the model prediction in turn affects the quality of the bidding optimization directly. To protect user privacy, the API does not return the event-level data with full fidelity. Rather, a small proportion of interactions are randomly chosen by the browser/platform to be assigned random conversion metadata. In addition, there are limits on how much metadata can be extracted from the conversions.

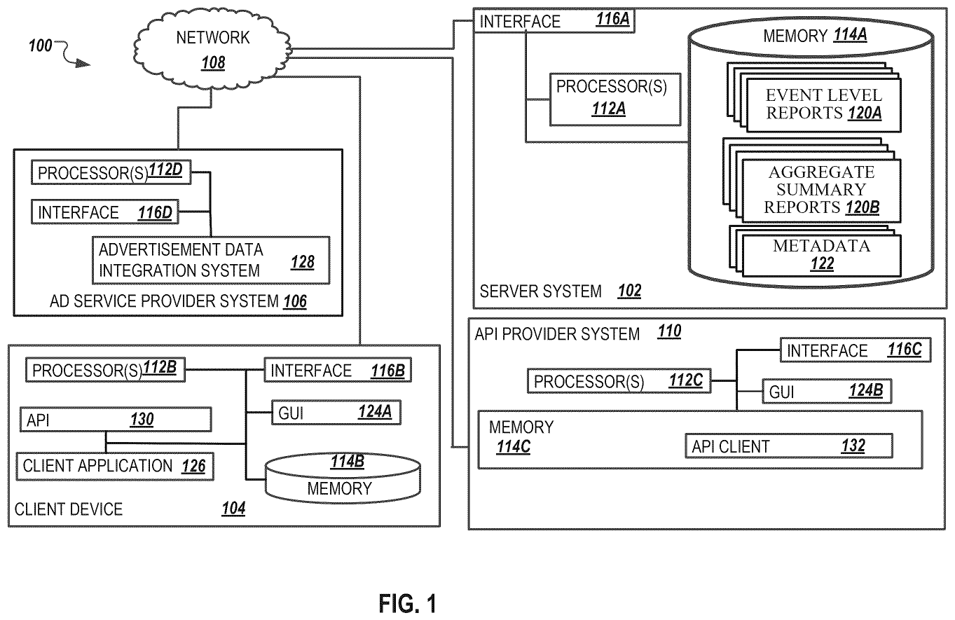

FIG. 1 is a block diagram illustrating an example system 100 for derivation of interaction measurements from API reports. Specifically, the illustrated example system 100 includes or is communicably coupled with a server system 102, a client device 104, a content provider system (and/or asset provider systems) 106, an API provider system 110, and a network 108. Although shown separately, in some implementations, functionality of two or more systems or servers may be provided by a single system or server. In some implementations, the functionality of one illustrated system, server, or component may be provided by multiple systems, servers, or components, respectively.

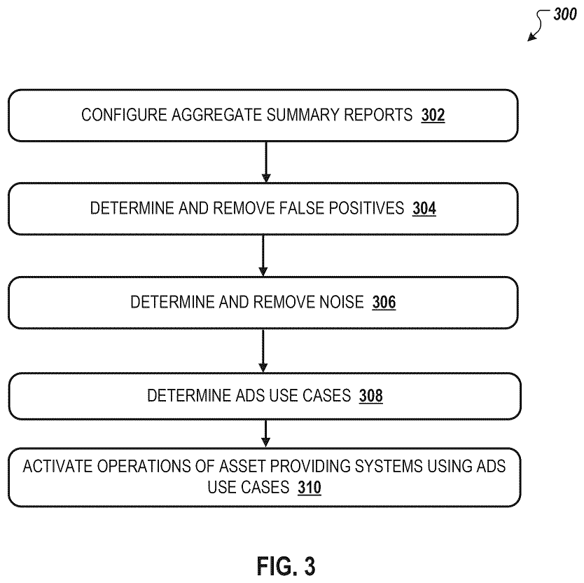

In the example of FIG. 1, the server system 102 is intended to represent various forms of servers including, but not limited to a web server, an application server, a proxy server, a network server, and/or a server pool. In general, server systems 102 accept requests for application services, such as testing services, advertisement services, experimental services, and provides such services to any number of client devices 104 (e.g., the client device 104 over the network 108). In accordance with implementations of the present disclosure, and as noted above, the server system 102 can host a solution environment that can be a cloud environment providing software applications, systems, and services, such as content display on client devices 104 within applications that can be consumed by entities as a service. The interaction generated in response to the provided service can be measured and can be provided to content provider systems (and/or asset provider systems) 106. In some instances, the server system 102 can support configuring APIs of different types, as well as services of different types that are integrated in user privacy settings (scenarios) and support execution of processes, as described with reference to FIGS. 3, 5, 8, and 10A-10C.

The server system 102 includes a processor 112A, a memory 114A and an interface 116A. The memory 114A can include event level reports 120A, aggregated summary reports 120B, and metadata 122. The event level reports 120A, aggregated summary reports 120B can include documents defining events (e.g., interactions with user interfaces) recorded by resources (APIs) provided by API provider system(s) 110. The metadata 122 provides additional information related to ad-interactions and/or conversions. In some implementations, metadata 122 can include encoded data pointing to API configurations (e.g., defining conversion types applied by respective APIs).

The client device 104 and the API provider system 110 may each be any computing device operable to connect to or communicate in the network(s) 108 using a wireline or wireless connection. In general, each of the client device 104 and the API provider system 110 includes an electronic computer device operable to receive, transmit, process, and store any appropriate data corresponding to the system 100 of FIG. 1. Each of the client device 104 and the API provider system 110 is generally intended to encompass any computing device such as a laptop/notebook computer, wireless data port, smart phone, personal data assistant (PDA), tablet computing device, one or more processors within these devices, or any other suitable processing device. The client device 104 and the API provider system 110 respectively include interface(s) 116B, 116C, processor(s) 112B, 112C, memories 114B, 114C, and graphical user interface(s) (GUIs) 124A, 124B.

The client device 104 can include one or more client applications 126. The client application 126 can be any type of application that allows a client device to request and view content on the client device (e.g., internet browsers). In some implementations, a client application 126 can be corresponding to an API that can record user parameters, metadata, and other API event information that can be processed in a particular way to preserve user privacy before data (event level reports 120A, aggregated summary reports 120B) transmission to the server 102. In some instances, a client application 126 may be an agent or client-side version of the one or more enterprise applications running on an enterprise server (not shown). The memory 114C of the target API provider system 110 can include an API client 132, API resources 134, and event resources 136 that can be used for integration dependency.

The client device 104 and/or the API provider system 110 may comprise a computer that includes an input device, such as a keypad, touch screen, or other device that can accept user information, and an output device that conveys information corresponding to the operation of the server 102, or the client device itself, including digital data, visual information, or a GUI 124A, 124B, respectively. The GUI 124A, 124B each interface with at least a portion of the system 100 for any suitable purpose, including generating a visual representation of the client application 126 or the administrative application 133, respectively. In particular, the GUIs 124A, 124B may each be used to view and navigate various Web pages. Generally, the GUIs 124A, 124B each provide the user with an efficient and user-friendly presentation of object data (metadata) provided by or communicated within the system. The GUIs 124A, 124B may each comprise a plurality of customizable frames or views having interactive fields, pull-down lists, and buttons operated by the user during recordable events that can be included in API collected data (e.g., event level reports 120A, aggregated summary reports 120B). The GUIs 124A, 124B each contemplate any suitable graphical user interface, such as a combination of a generic web browser, intelligent engine, and command line interface (CLI) that processes information and efficiently presents the results to the user visually.

The content provider systems (and/or asset provider systems) 106 can include multiple systems that exist in a multi-system landscape. An organization can use different systems, of different types, to run the organization, for example. The content provider systems (and/or asset provider systems) 106 can include systems from a same entity or different entities. The content provider systems (and/or asset provider systems) 106 can each include at least one of an interface 116D, a processor 112D, and an interaction data integration system 128. The interaction data integration system 128 can include an implementation of operations associated to statistical data indicative of interaction measurements. The operations implementation capabilities include a set of criteria to select and trigger automatic implementation of an operation based on the statistical event-attributed data. The interaction data integration system 130 can filter the entity landscape to identify suitable operation target, from multiple asset provider systems 106, based on API configurations and can automatically select an identified API provider systems 110 for establishing connections to any of the client device 104 and/or the API provider system 110, over the network 108.

In some implementations, the network 108 can include a large computer network, such as a local area network (LAN), a wide area network (WAN), the Internet, a cellular network, a telephone network (PSTN) or an appropriate combination thereof connecting any number of communication devices, mobile computing devices, fixed computing devices and server systems. Data exchanged over the network 108, is transferred using any number of network layer protocols, such as Internet Protocol (IP), Multiprotocol Label Switching (MPLS), Asynchronous Transfer Mode (ATM), Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 112A, 112B, 112C, 112D included in the client device 104, content provider systems (and/or asset provider systems) 106, or the API provider system 110 may be a central processing unit (CPU), an application specific integrated circuit (ASIC), a field-programmable gate array (FPGA), or another suitable component. Generally, each processor 112A, 112B, 112C, 112D included in the client device 104 or the API provider system 110 executes instructions and manipulates data to perform the operations of the client device 104 or the API provider system 110, respectively. Specifically, each processor 112A, 112B, 112C, 112D included in the client device 104 or the API provider system 110 executes the functionality used to send requests to the server 102 and to receive and process responses from the server 102. Each processor 112A, 112B, 112C, 112D may be a central processing unit (CPU), a blade, an application specific integrated circuit (ASIC), a field-programmable gate array (FPGA), or another suitable component. Each processor 112A, 112B, 112C, 112D executes instructions and manipulates data to perform the operations of the respective system (the server system 102, the client device 104, the API provider system 110, and the content provider systems (and/or asset provider systems) 106). Specifically, each processor 112A, 112B, 112C, 112D executes the functionality used to receive and respond to requests from the respective system (the server system 102, the client device 104, the API provider system 110, and the content provider systems (and/or asset provider systems) 106), for example.

Interfaces 116A, 116B, 116C, 116D are used by the server 102, the client device 104, the landscape system 106, and the API provider system 110, respectively, for communicating with other systems in a distributed environment—including within the system 100—connected to the network 108. Generally, the interfaces 116A, 116B, 116C, 116D each include logic encoded in software and/or hardware in a suitable combination and operable to communicate with the network 108. More specifically, the interfaces 116A, 116B, 116C, 116D may each include software supporting one or more communication protocols corresponding to communications such that the network 108 or interface's hardware is operable to communicate physical signals within and outside of the illustrated system 100.

The memory 114A, 114B, 114C may include any type of memory or database engine and may take the form of volatile and/or non-volatile memory including, without limitation, magnetic media, optical media, random access memory (RAM), read-only memory (ROM), removable media, or any other suitable local or remote memory component. The memory 114A, 114B, 114C may store various objects or data, including caches, classes, frameworks, applications, backup data, objects, jobs, web pages, web page templates, database tables, database queries, repositories storing entity information and/or dynamic information, and any other appropriate information including any parameters, variables, algorithms, instructions, rules, constraints, or references thereto corresponding to the purposes of the server system 102, the client device 104, the API provider system 110, or the landscape system 106, respectively.

There may be any number of client devices 104 and API provider systems 110 corresponding to, or external to, the system 100 for collecting and processing interaction event data. Additionally, there may also be one or more additional client devices external to the illustrated portion of system 100 that are capable of interacting with the system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1 illustrates a single server 102, a single client device 104, a single API provider system 110, the system 100 can be implemented using a single, stand-alone computing device, two or more servers 102, or multiple client devices. The server system 102, the client device 104 and the API provider system 110 may include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 and the API provider system 110 may be adapted to execute any operating system or runtime environment, including Linux, UNIX, Windows, Mac OS®, Java™, Android™, iOS, BSD (Berkeley Software Distribution) or any other suitable operating system. According to one implementation, the server 102 may also include or be communicably coupled with an e-mail server, a Web server, a caching server, a streaming data server, and/or another suitable server.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, ABAP (Advanced Business Application Programming), ABAP OO (Object Oriented), any suitable version of fourth-generation programming language, as well as others. While portions of the software illustrated in FIG. 1 are shown as individual engines that implement the various features and functionality through various objects, methods, or other processes, the software may instead include multiple sub-engines, third-party services, components, libraries, and such, as appropriate. Conversely, the features and functionality of various components can be combined into single components as appropriate.

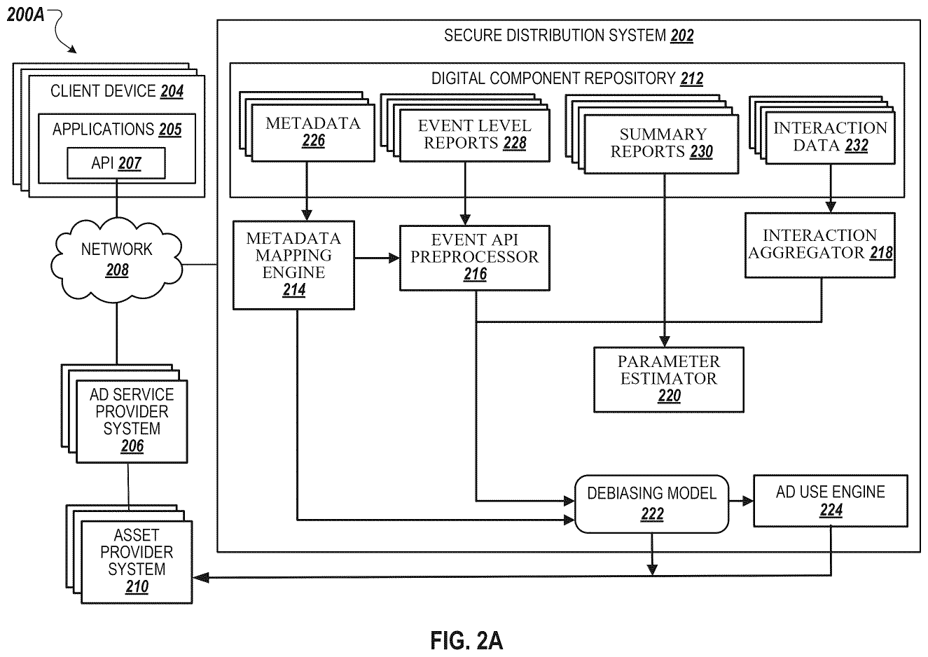

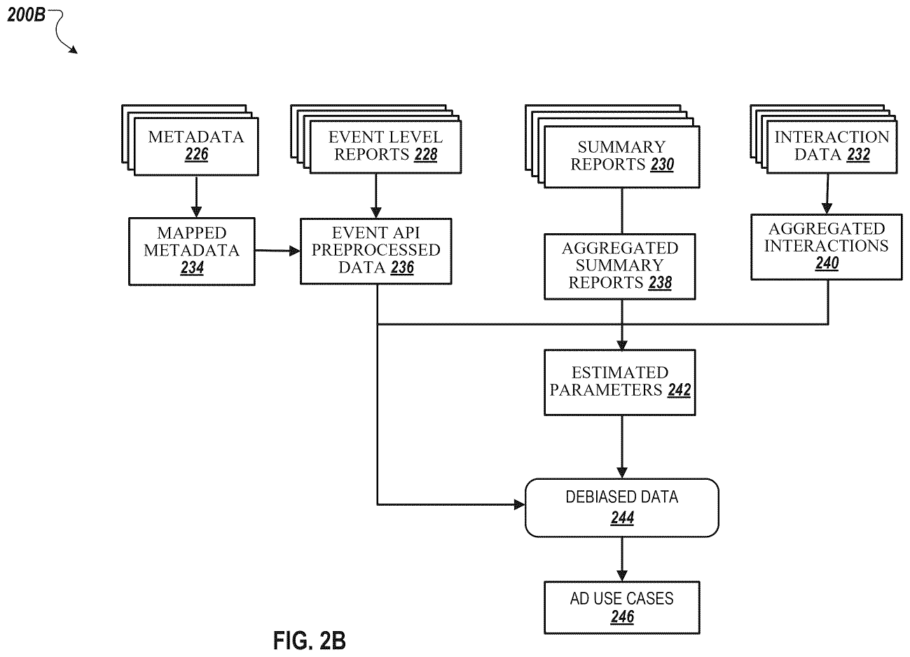

FIG. 2A is a block diagram of an example system 200A for debiasing interaction measurement data using a secure distribution system 202. The illustrated example system 200 includes or is communicably coupled with a secure distribution system 202, a client device 204, a content provider system 206, an asset provider system 210, and a network 208. The secure distribution system 202 can be included in a server system (e.g., server system 102 described with reference to FIG. 1). Although shown separately, in some implementations, the secure distribution system 202 can be included in any of the client device 204 (e.g., client device 104 described with reference to FIG. 1), the content provider systems 206 (e.g., system 106 described with reference to FIG. 1), or the asset provider system 210 (e.g., system 106 described with reference to FIG. 1) or can be communicatively coupled over the network 208 (e.g., network 108 described with reference to FIG. 1) to any of the client device 204, the content provider system 206, and the asset provider system 210.

The client device 204 can include applications 205, such as web browsers and/or native applications, to facilitate the sending and receiving of data over the network 208. A native application is an application developed for a particular platform or a particular device (e.g., mobile devices having a particular operating system). Although operations may be described as being performed by the client device 204, such operations may be performed by an application 205 running on the client device 204. The applications 205 can present electronic resources, e.g., web pages, application pages, or other application content, to a user of the client device 204. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of the document, a resource can refer to a web page, application page, application content presented by a native application, electronic document, audio stream, video stream, or other appropriate type of electronic resource with which a digital component can be presented. As used throughout the document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include service (e.g., testing or advertising) information, such that an interaction is a type of digital component. For example, the digital component may be content that is intended to supplement content of a web page or other resource presented by the application 205. More specifically, the digital component may include digital content that is relevant to the resource content (e.g., the digital component may relate to the same topic as the web page content, or to a related topic). The provision of digital components can supplement, and generally enhance, the web page or application content.

In response to the application 205 loading a resource that includes a digital component slot, the application 205 can generate a digital component request 225 that requests a digital component for presentation in the digital component slot. In some implementations, the digital component slot and/or the resource can include code (e.g., scripts) that cause the application 205 to request a digital component from the content provider system 206 that can be recorded by the API 207 as interaction event data.

The interaction event data recorded by the API 207 can include data related to a user of the client device 204 and/or non-sensitive data, such as query strings. The data related to the user can include, for example, data identifying user groups that include the user as a member. The user groups can include interest-based groups. Each interest-based group can include a topic of interest and a set of members identified (e.g., determined or predicted) to be interested in the topic. The user groups can also include, for example, groups of users that performed particular actions at electronic resources (e.g., websites or native applications) of publishers. For example, a user group can include users that visited a website, users that requested more information about an item, interacted with (e.g., selected) a particular digital component and/or added an item to a virtual cart to potentially acquire the item. The data related to the user can also include user profile data and/or attributes of the user.

Further to the descriptions throughout the document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, particular data may be processed in one or more ways before it is transmitted to be stored, by the digital component repository 212 of the secure distribution system or used, so that personally identifiable information is truncated (at least partially removed) and noise is added to hide private data. For example, a user's identity may be treated so that no personally identifiable information can be determined for the user, or a user's geographic location may be generalized where location information is obtained (such as to a city, ZIP code, or state level), so that a particular location of a user cannot be determined. The user may have control over what information is collected about the user, how that information is used, and what information is provided to the content provider system 206 and the asset provider system 210.

Interaction event data, recorded by the API 207, can also include contextual data, which is generally considered non-sensitive. The contextual data can describe the environment, in which a selected digital component was presented. The contextual data can include, for example, coarse location information indicating a general location of the client device 204 that sent the digital component request, a resource (e.g., website or native application) with which the selected digital component will be presented, a spoken language setting of the application 205 or client device 204, the number of digital component slots, in which digital components are presented with the resource, the types of digital component slots, and other appropriate contextual information.

The secure distribution system 202 can be implemented using one or more server computers (or other appropriate computing devices), that may be distributed across multiple locations. In general, the secure distribution system 202 receives requests for digital components from client devices 204, selects digital components based on data included in the requests, and sends the selected digital components to the client devices 204. In some implementations, the secure distribution system 202 can be operated and maintained by an independent trusted party, e.g., a party that is different from the users of the client devices, the parties that operate supply side platform (SSP) and demand side platforms (DSPs), and the digital component providers, to ensure security and privacy with respect to the data. For example, the secure distribution system 202 can be operated by an industry group or a governmental group.

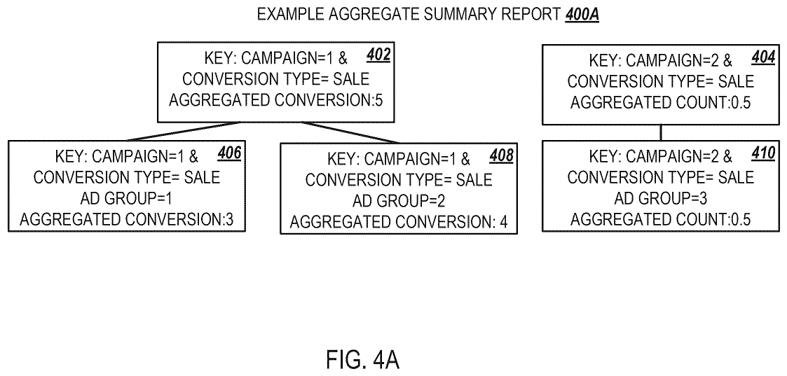

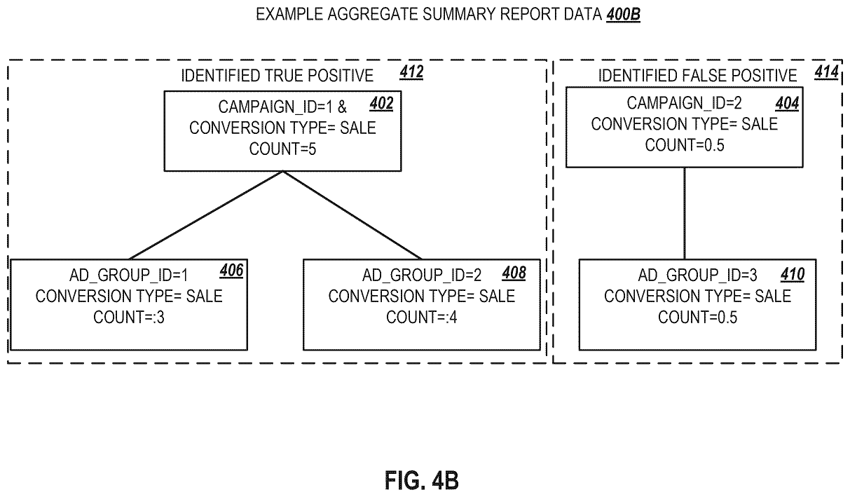

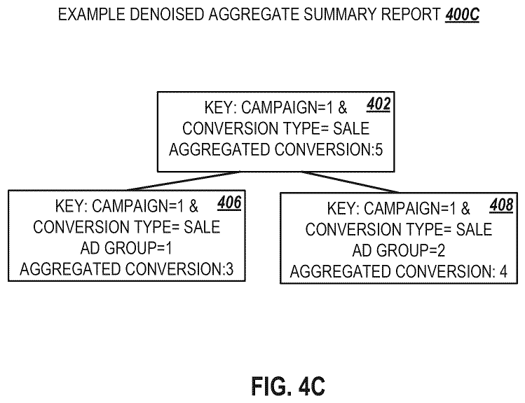

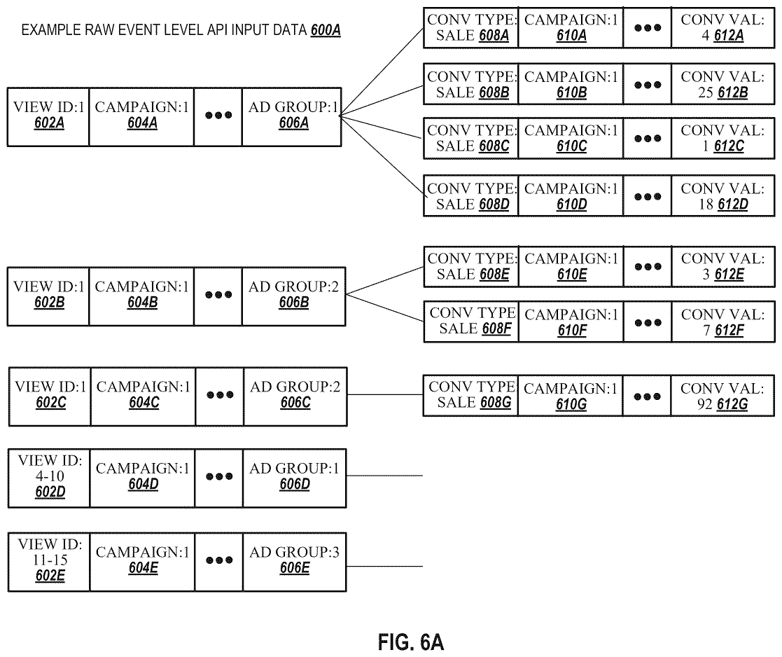

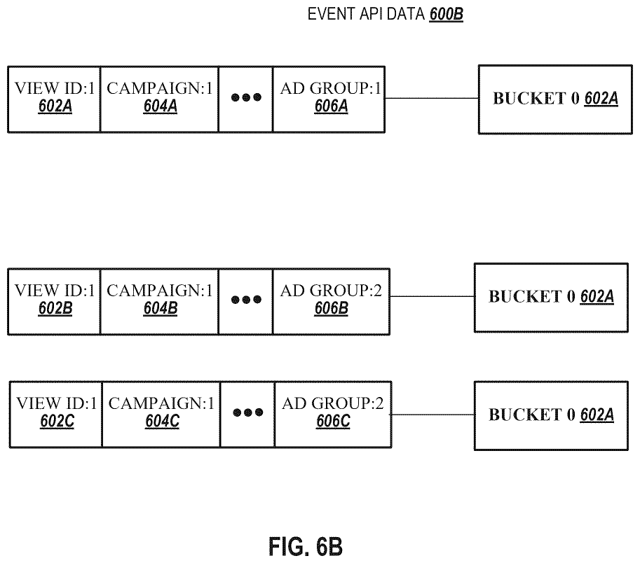

The secure distribution system 202 can include a digital component repository 212, a metadata mapping engine 214, an event API preprocessor 216, an interaction aggregator 218, a parameter estimator 220, a deep biasing engine 222, and an interaction use engine 224. The digital component repository 212 can be a database configure tool store data including data received from API such as metadata 226, event level reports 228, summary reports 230, and interaction data 232. The event level reports 228 and the summary reports 230 can include eventified and modeled data logs, which reflect the same information content in two types of reports that provide different levels of granularity (one more detailed, and one more in summary form). As described with reference to FIGS. 4A-4C and 6A and 6B, the event level reports 228 and the summary reports 230 include tabulated logs with rows representing interaction-events and columns representing the outcomes (conversion counts and conversion values) attributed to the interaction-events.

The metadata mapping engine 214 can access (obtain or retrieve) the metadata 226 from the digital component repository 212 and provide an output of metadata processing to the event API preprocessor 216. The metadata mapping engine 214 can filter out some conversions by looking up a metadata mapping table that can be stored by the digital component repository 212. If the metadata 226 for an identified log entry is not registered inside the metadata mapping table, it is determined that the conversion of the log entry is on the fake branch.

The event API preprocessor 216 can be configured to process the input received from the metadata mapping engine to 214 and event level reports 228 retrieved from the digital component repository 212 to generate an output that is provided to the parameter estimator 220 and the debiasing engine 222. The interaction aggregator 218 can access (obtain or retrieve) the interaction data 232 from the digital component repository 212 and provide an output of interaction data processing to the parameter estimator 220.

The debiasing engine 222 can be a data process pipeline using a log aggregator (e.g., Flume C++) and a protocol buffer. The debiasing engine 222 can include a debiasing layer to regularly run the pipeline and to generate debiased event API data by processing the inputs received from the event API preprocessor 216 and the parameter estimator 220. For example, the data derived, by the event API preprocessor 216, from the event-level reports 228, can be processed, by the debiasing engine 222, using aggregate information derived from the aggregated summary reports 230 to recover the underlying 3PC conversions applied to the interaction data, while retaining the event-level nature of the interaction data. Because of the privacy protection nature of the API, the recovered data is not identical to the event-level 3PC affirmative action data, but the output of the debiasing engine 222 includes an actionable event-level data log that nevertheless be used for interaction use-cases, by the interaction use engine 224.

In some implementations, the debiasing engine 222 performs a post mapping process based on (trainable) machine learning models, which map the conversion metadata value to conversion types or biddability information. The machine learning models can be trained using as input a training dataset with units of interaction-events and attributed conversion (or conversion values) combinations, matching the structure of the eventified logs. Building both the reporting and the offer generation (e.g., bidding to a group of service providers) off the same log can reduce processing complexity and automatically provides consistency across use-cases. For example, the debiasing engine 222 can be used to train a machine learning model on the denoised aggregates and the event-level report data to predict values for the eventified log, resulting in a trained model. The conversions (or conversion values) can be provided to the training system as input features, and the interaction-event characteristics contain values can be provided to the training system as target outputs. The debiasing engine 222, during training phase, can select the type of machine learning model to be trained, e.g., pick a predefined or default type of machine learning model, or analyze the input features and the target outputs to identify a particular type of machine learning model. For example, types of machine learning models can include a gradient boosted trees model, a generalized linear model, a support vector machine, a decision tree model, or a neural network model, e.g., a multilayer perceptron (MLP). The machine learning models can be trained using machine learning training algorithms such as minimizing an error, computing a gradient, or performing backpropagation. In some implementations, the training system can use the metadata corresponding to denoised aggregates and the event-level report data to preprocess the values of the interaction-event characteristics to provide to the training system. For example, by using metadata that identifies the type of data for the values, the system can preprocess the values so that the training system can more accurately interpret the values. In other words, the training system can map the conversion values in the cell into encoded representations that can be provided as input features for the training of the machine learning model. For example, the system can convert each pair of denoised aggregates and the event-level report data to predict values for the eventified log in a format (such as shown in FIG. 6A) that the content provider system 206 and/or the asset provider system 210 can interpret, such as for use cases that can be identified by the interaction use engine 224.

The debiased data is sent to the interaction use engine 224 and, optionally, to the content provider system 206 and the asset provider system 210. The interaction use engine 224 can process the debiased data to identify use cases associated to the debiased data. The interaction use engine 224 can send the use cases associated to the debiased data or a control command associated to one or more the use cases to the content provider system 206 and the asset provider system 210.

As used in this specification, eventification refers to the process of extracting the event-level 3PC affirmative action data from the event-level reports 228 and the aggregated summary reports 230. Eventification has multiple advantages. One advantage of eventification is that even though utilizing a different measurement technology altogether, the eventified log is similar in structure to the event-level data recorded by third party cookies. The structure similarity facilitates the insertion of the eventified log into existing data pipelines and other modeling infrastructure built for 3PC data with little changes. The compatibility of the eventified log with existing data pipelines reduces technical debt, facilitating the transition to systems including ARA API. Another advantage of eventification is that the same eventified log can be used for many use-cases, including top ranked (one or two) dominant use-cases of reporting and bidding. For reporting, the eventified log can be aggregated as appropriate to the slice for which reporting is used, for example at the campaign level. For bidding, eventification facilitates training of machine learning models using conversions (or conversion values) as labels and with interaction-event characteristics as features. The training of machine learning models uses as input a training dataset with units of interaction-events and attributed conversion (or conversion values) combinations, matching the structure of the eventified logs. Building both the reporting and the bidding off the same log can reduce processing complexity and automatically provides consistency across use-cases.

FIG. 2B is a block diagram of an example data flow within the secure distribution system 202, described with reference to FIG. 2A. The secure distribution system 202 is configured as an API denoising layer architecture, according to some implementations of the present disclosure.

The metadata 226, the event level reports 228, the summary reports 230, and the interaction data 232 can be processed in parallel by computing components, as described with reference to FIG. 2A to generate eventified debiased data 244 that can be used to determine interaction use cases 246.

The metadata 226 can be formatted as tables with entries including context data corresponding to user interactions recorded by APIs. The metadata 226 can be processed to generate mapped metadata 234.

The event level reports 228 generated by APIs include truncated raw event level reports that can be assigned to one or more buckets. The event level reports 228 can be processed to differentiate between events corresponding to fake and true branches and to generate event API preprocessed data 236.

The summary reports 230 transmitted by APIs include aggregated summary reports 238 generated from raw summary reports and added noise (false reports). The aggregated summary reports 238 can be processed to estimate interaction parameters 242.

The interaction data 232 can be extracted and collected from different channels configured to generate interaction logs. The interaction data 232 can be processed to generate aggregated interactions 240. The aggregated interactions 240 can also be used to determine estimate interaction parameters 242.

The estimate interaction parameters 242 can be processed to generate debiased event data 244. The debiased event data 244 includes interaction data extracted from the aggregated summary reports 238 and the event level reports 228 based on underlying 3PC conversions applied to protect user data privacy. The debiased event data 244 has the same structure type as the original interaction data, lacking private user information or having private user information replaced with generic user information. The debiased event data 244 can be processed to generate interaction use case data 246 without breaching privacy and security measures imposed by system privacy settings.

FIG. 3 is a flowchart of an example process 300, according to some implementations of the present disclosure. The example process 300 can be executed using, e.g., any component of the example system 100 described with reference to FIG. 1 or example system 200 described with reference to FIG. 2. Operations of the process 300 are described below for illustration purposes only. Operations of the process 300 can be performed by any appropriate device or system, e.g., any appropriate data processing apparatus. Operations of the process 300 can also be implemented as instructions stored on a computer readable medium which may be non-transitory. Execution of the instructions causes one or more data processing apparatus to perform operations of the process 300.

Aggregated summary reports are received, by one or more processors of a computing device (e.g., the server system 102 described with reference to FIG. 1 or the secure distribution system 202 described with reference to FIG. 2) from APIs of client devices (e.g., the client device 104, 204 described with reference to FIGS. 1 and 2) (302). The aggregated summary reports include data aggregates. The data aggregates include grouping of event-attributed affirmative action data that is aggregated to a slice level. The aggregated summary reports are configured based on a pre-definition of the slices over which an interaction provider system plans to learn about conversion activity. For example, the aggregated summary reports can be configured to provide information focused on answering a particular question, like “How many conversions were there in a particular country?” or “What was the sum total of purchase values yesterday?” The type of information used for aggregation is especially useful for reporting use-cases, by which service (e.g., testing or advertising) provider systems can gain insights about the offered interaction-campaign, as opposed to a click-by-click (or view-by-view) basis. Even though, the aggregated summary reports are structured to provide aggregated data associated to a particular topic, the underlying raw aggregated summary report can provide additional information beyond the initial aggregation scope. To extract additional information, the aggregated summary reports can be formatted relative to the applied structure configuration. The configuration of the aggregated summary reports includes an adjustment of the limits off the aggregated summary reports. The limits in the aggregated summary reports can be configured by distributing the per-interaction sensitivity parameter across several conversions that can potentially be implemented by the APIs to protect privacy of user data related to interaction events (e.g., interactions with user interfaces displaying interaction). The aggregated summary reports offer a type of flexibility that can be used to capture the attribution configuration.

False positives are identified and removed (304). False positives can be determined by analyzing whether an event-level report is available or not. The “hierarchical” structure includes end arrangement of aggregates in a tree-like structure, where parent “leaves” are split into children “leaves” with each additional key. The hierarchy of the aggregated summary reports includes aggregate slices corresponding to parent event nodes and children event nodes, wherein unrelated branches including one or more nodes can correspond to false positive reports. The false positive reports are aggregate slices that are determined to have been artificially added to the aggregated summary reports without being related to any conversions of true user interactions. The results in aggregate slices that falsely appear to include conversions define false positives that are identifiable based on whether an event-level report is available or not. The structure schema (aggregation keys) used for aggregations can be stored in a database (e.g., the digital component repository 212, described with reference to FIG. 2). For example, the ARA used to generate the aggregation structure can be pre-registered by the content provider system (e.g., the content provider system 106, 206, described with reference to FIGS. 1 and 2) before the aggregated summary reports are received. In some implementations, the content provider systems can register multiple aggregate keys that can be used for conversions. False positive identification can include processing the aggregated summary report using each of them aggregation keys that are being stored. In response to identifying false positives representing error-filled aggregates in the configured aggregated summary reports, the false positives are removed from the data. A variety of techniques can be implemented to filter out false positives. In some implementations, the event-level reports can used to reduce false positives. For example, if click-through conversion (CTC) setting is considered, each click can register a triplet of conversions, each corresponding to a triplet of bits of metadata, over three-time windows. If a click is indicated in the aggregated summary reports that resulted in a conversion but was reported by the event-level reports as having no conversions, the respective click can be a false positive on a noised branch.

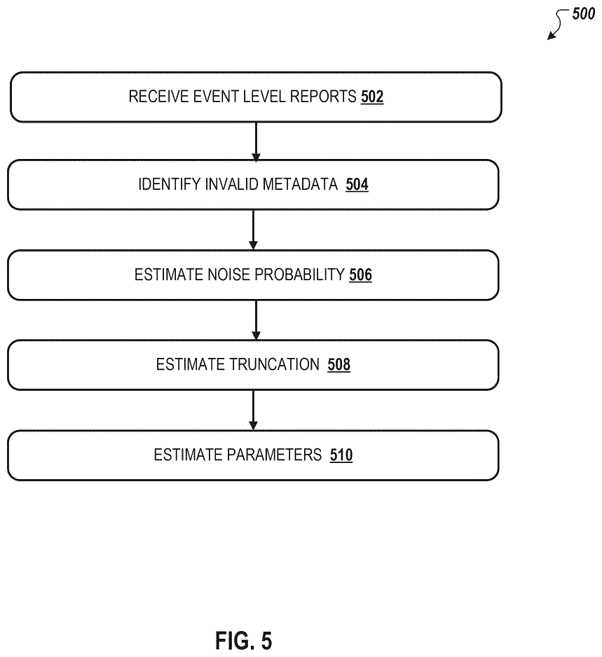

The noise is determined and reduced to generate raw aggregated summary reports are generated (306). The noise identification procedure can be based on the hierarchical structure of the configured aggregated summary reports. Noise is added (e.g., by the API) to the aggregate data to protect user privacy, but the nature of the noise is different than in the event-level reports described with reference to FIGS. 5-7. Whereas the event-level reports use a local-differential privacy (DP) model for adding noise, the differential privacy mechanism in the aggregated summary reports is a central-DP model. Local-DP means that each interaction is subject to noise; central-DP means that noise is only added after some aggregation has occurred. As a difference to the noising mechanism in the event-level reports (randomized response), the aggregated summary reports use a Laplace noising mechanism. The noise added using Laplace noising mechanism includes a random variate from a Laplace distribution that is added to the aggregates. For example, event-level attributed conversions following interaction-events are truncated by the contribution bound; the truncated conversions are aggregated to a slice-level; and Laplace noise is added to that aggregate slice and reported. The aggregated summary reports use no specific structure nor a predefined set of keys over which to aggregate; that is addressed by the content provider system. The magnitude of the noise added to the aggregates is technically fixed, drawn from a Laplace distribution with mean 0 and standard deviation 2L1/ϵ, where L1 and ϵ are respectively the sensitivity of the data and the intended privacy level. The noise can be reduced from all slices of the aggregated summary reports. Statistical distribution of data can be determined to identify potential noise. For example, a particular entry type (e.g., campaign-level) aggregate can be compared with the sum of conversions across all interaction-groups in the respective entry type (campaign). If the comparison indicates that the measurements correspond to approximately the same quantity, the entry type aggregates in “A” can combined with the aggregates in the sum of conversions across all interaction-groups in the respective entry type “B”+“C” to improve the estimate of the quantity. In some implementations, Laplace noise that is centered at 0 and was added additively to the aggregated summary reports can be reduced by taking linear weighted averages of “A” and “B”+“C”, which would represent an unbiased estimate of the number of conversions. Another example approach for reducing noise is applying a skewed weighted average, which minimizes the final variance of the parent node estimate. The result is an improved estimate of the conversion (configuration) count included in the configured aggregated summary report. Note that the skewed weighted average approach can include a second “top-down” pass to pass information down the tree, ultimately benefiting the most granular aggregates. The top-down approach looks at the difference between a slice and its children and distributes the difference across the child nodes. The described noise reduction process provides “consistency” in that each slice's conversion count is exactly equal to the sum of its children; wherein raw API outputs do not share the property.

Interaction use cases are determined for the raw aggregated summary reports (308). For example, digital components associated to statistical data derived from the raw aggregated summary reports can be identified using data content mapping and obtained from a data base. The mapped digital components can be electronically stored in a physical memory device as a single file or in a collection of files, such as video files, audio files, multimedia files, image files, or text files and include advertising information, such that an interaction is a type of digital component. For example, the digital component may be content that is intended to supplement content of a web page or other resource presented by an application executed by a client device. More specifically, the digital component may include digital content that is relevant to the resource content (e.g., the digital component may relate to the same topic as the web page content, or to a related topic). The provision of digital components can supplement, and generally enhance, the web page or application content providing access to an asset providing system.

A trigger to activate the operations of asset providing systems using interaction use cases is generated (310). The trigger can automatically activate execution of one or more operations corresponding to the determined interaction use cases. The operations can include establishment of a communication channel with the client devices, transmission of the digital components from the database to the client devices, and/or transmission offers corresponding to the digital component from asset providing systems to the client devices. The operations can include an automatic modification of a display of the client devices to increase a visibility of the automatically triggered display of the digital component.

FIGS. 4A-4C are a block diagram showing examples of aggregated summary reports, according to described implementations. FIG. 4A illustrates an example of an aggregated summary report 400A that can be generated by an API. FIG. 4B illustrates example aggregated summary report data 400B that can be included in the example aggregated summary report 400B. FIG. 4C illustrates an example of denoised aggregated summary report 400C.

As shown in FIGS. 4A-4C, the aggregated summary reports are hierarchically structured, including one or more parent nodes 402, 404 and one or more child nodes 406, 408, 410. Each parent node 402 or 404 can have one or more child nodes 406, 408, or 410, respectively. Each node of a particular type can include a set of data types. For example, the parent nodes 402, 404 can include keys, conversion (configuration) types, and aggregated conversion (configuration) counts. Each child node of a particular type can include a set of data types. For example, the child nodes 406, 408, 410 can include the set of data types of the respective parent node and one or more additional data. In the illustrated examples, the child nodes 406, 408, 410 include keys, conversion types, ad groups, and aggregated conversion counts.

In the illustrated example, the aggregated summary report 400A is aggregated as “keys” (e.g., Campaign ID, Ad Group, Conversion Type), a specific instantiation of those keys as “key-values” (Campaign ID==1, Ad Group==1, Conversion Type==“Sale”) and the aggregate data corresponding a particular key-value as an “aggregate.” The data reported in each box in the aggregated summary report 400A is an “aggregate” representing a specific combination of the event and conversion characteristics. The aggregated summary report 400A provides datasets whose elemental granularity is at the level of aggregates. The aggregates reported by the Aggregate-API are not perfectly accurate because the aggregated summary report 400A, includes statistical noise that is added to the counts for differential privacy reasons. The data in the aggregated summary report 400A has been aggregated in a specific way: first, by Campaign, then by Conversion type first; and then by interaction-group. The specifics of the aggregates and how the aggregates can be organized is under the control of the content provider system. The content provider system can choose to aggregate the data in a way that can be mapped to a particular operation of an interaction use case. The aggregated summary reports can report a result even in cases where there were no factual conversions due to the noising mechanism introduced to protect user data privacy. In the illustrated example, the two boxes on the right report some conversions for Campaign 2, wherein in reality there were none.

The aggregated summary report 400A can be configured to be within set limits of how many contributions can be registered against a given interaction for representation in the aggregated summary reports. The event-level conversions following an interaction-event can be truncated by the set limits, and aggregates can be based on the truncated conversions. The limits can manifest in undersized aggregates if the conversion activity exceeds them. The limits in the aggregated summary reports can be configured by the content provider system by distributing the per-interaction L1 sensitivity parameter across potentially several conversions. The aggregated summary reports can offer a type of flexibility which can be used to capture the attribution picture better.

In the illustrated example, the aggregated summary report data 400B includes two keys: Campaign ID and interaction-group ID. The hierarchical structure allows for some flexibility to the content provider system. When the number of conversions is low, the noise added by the aggregated summary reports may overwhelm the true conversion count in its aggregates, wherein collection by the content provider system of aggregates at a coarser level, at the top of the hierarchy can make data collection and processing more efficient in terms of system resources. On the other hand, when the number of conversions is high, the impact of noise may be lower relative to the true conversion count in the aggregates, and it makes more sense to collect aggregates at a more granular level at the lower part of the hierarchy. Using a hierarchal structure provides the flexibility to the content provider system to finetune the tradeoff between information and accuracy in its aggregates depending on particular situations. The hierarchical structure can be helpful to efficiently combine information at multiple levels to improve the quality of aggregates across the tree as a whole. The hierarchal structure can be used to identify and separate true positive data 412 from false positive data 414 that can be reduced to generate denoised aggregated summary report data 400C that has false positive data 414 reduced.

In the example illustrated in FIGS. 4A-4C, a “slice” 402, 404, 406, 408, 410 corresponds to data aggregated within a particular node, or combination of key-values, on the aggregate tree. Although the illustrated aggregated summary report 400A includes a hierarchical structure, other aggregation techniques can be used when considering other types of aggregations (such as total conversion value).

FIG. 5 is a flowchart of an example debiasing process 500, according to some implementations of the present disclosure. The example process 500 can be executed using any component of the example system 100 described with reference to FIG. 1 or example system 200 described with reference to FIG. 2. Operations of the process 500 are described below for illustration purposes only. Operations of the process 500 can be performed by any appropriate device or system, e.g., any appropriate data processing apparatus. Operations of the process 500 can also be implemented as instructions stored on a computer readable medium which may be non-transitory. Execution of the instructions causes one or more data processing apparatus to perform operations of the process 500.

Event level reports (e.g., example event level data 600B described with reference to FIG. 6B) are received, by a computing device from APIs of client devices (502). The term “event” in event-level reports corresponding to interaction-events generated according to multiple conversion (configuration) types. The granularity of an event-level report is defined by an interaction, such as a click or a view. Along with the interaction, the API returns information about any conversions that may (or may not) have happened within a predefined duration after the interaction. Data coming from the event-level reports can be paired with metadata corresponding to the respective conversion(s). To protect user privacy, the API does not return the event-level data with full fidelity (without deviations). A small proportion of ad-interactions are randomly chosen by the API to be assigned random conversion (configuration) metadata. In some implementations, limits can be set on how much metadata can be extracted from the conversions.

The event level reports are processed to identify invalid metadata to identify events are determined to be on a fake branch (504). The event level reports can be processed using a metadata filter applied by a metadata mapping engine (e.g., metadata mapping engine 214 described with reference to FIG. 2A). The events in the event level reports can be filtered based on metadata entries that can be mapped to the events. If the metadata for an identified log entry is not registered inside the metadata mapping table, it is determined that the conversion (configuration) of the log entry is on the fake branch, the respective metadata is identified as being invalid for each conversion type identifier (CTID) that facilitates identification of interaction events on the fake branch. The interaction events on the fake branch can be reduced to improve the signal-noise ratio and obtain higher accurate estimates. The invalid events feature 3-bit conversion metadata (or 1-bit for EVC/VTC) not registered by a given CTID (see Identify clicks on the fake branch for more information). Invalid interaction events can be reduced from the event level reports.

For events that were not certainly identified as being on the fake branch, the probability P(Fake|yᵢ) of each event of being on the fake branch is estimated (506). The term yᵢ is a vector of API-reported conversion counts for event i. Note that the probability of event i being on the true branch is:

$$P ( True \vert {y}_{i} ) = 1 - P ( Fake \vert {y}_{i} ) .$$

The probability estimation includes determining an estimate of the expected conversion count of each conversion type k and window w, μ_{kw}, k=1, . . . , K, w=1, . . . , W (supposing a total of K types and W windows). The expected total conversion count of each conversion type k and window wis determined considering that it may be truncated at n conversions, μ_{kw} (N_{kw}≥n), defined as μ (N≥n)=E(N|y=n, y=3).

If conversion type k is “before truncation” in window w,

$${\hat{n}}_{ikw} ( {y}_{i} ) = P ( True \vert {y}_{i} ) \times {y}_{ikw} + P ( Fake \vert {y}_{i} ) \times {μ}_{kw}$$

If conversion type k is being truncated in window w,

$${\hat{n}}_{ikw} ( {y}_{i} ) = P ( True \vert {y}_{i} ) \times {μ}_{kw} ( {N}_{kw} \geq {y}_{ikw} ) + P ( Fake \vert {y}_{i} ) \times {μ}_{kw}$$

If conversion type k is “post truncation” in window w,

$${\hat{n}}_{ikw} ( {y}_{i} ) = P ( True \vert {y}_{i} ) \times {μ}_{kw} + P ( Fake \vert {y}_{i} ) \times {μ}_{kw} = {μ}_{kw}$$

The parameters can be empirically estimated by combining the event-level API output, aggregate-level API output, and the ad event log data without relying on any other data sources (such as IPC data).

The probability estimate is:

$$P ( Fake \vert {y}_{i} = ω ) = \frac{Q \times {p}_{noise} \times p ( ω )}{C ( ω )} ,$$

The term ω is a specific configuration in the set of all possible conversion configurations for an event that the event-level API may report (Ω), Q is the total number of ad events of the CTID, p is the probability that an event noise ends up on the fake branch of the API, p(ω) is the probability that ω is drawn conditional on the event being on the fake branch, and C (ω) is the CTID's total number of events reported by the API with configuration ω. The information can be retrieved from the API configuration. The numerator is the expected number of interaction events that end up on the fake branch and have conversion configuration ω, and the denominator is the total number of events reported by the API with configuration ω, which include events on both the fake branch and the true branch. The ratio is defined as the probability of an event being on the fake branch conditional on observing ω. Note that it is not needed to assume a particular distribution for conversions on the true branch (e.g., a Poisson distribution), which can be inaccurate. Instead, the conditional probability can be estimated directly by leveraging the knowledge of the noising mechanism of the event-level API.

The debiased total conversion count of each conversion type and window Conv_{kw,agg} can be obtained from debiased aggregate-level API output for each conversion type and window to estimate the unconditional average. Dividing the debiased total conversion count by the total number of events Q from the interaction event logs can produce the conversion rate μₖᵥ:

$${μ}_{kw} ( {N}_{kw} \geq n ) , n = 0 , 1 , 2 , 3$$

The truncated averages are determined using the unconditional average (508). The truncation estimation process ensures that the debiased event-level API count matches with Conv_{kw,agg}, which significantly simplifies the design and implementation of the Newton Common Data Layer by naturally incorporating the-described merging step. The assumption is that

$$\text{?} = \text{?} , \text{?} = \text{?} , \text{?} = \text{?} \text{?}$$

$$\text{?} \text{indicates text missing or illegible when filed}$$

Where

$${N}_{tot} = \text{?} .$$

$$\text{?} \text{indicates text missing or illegible when filed}$$

The assumption claims that the ratio of the truncated mean at different truncation points for each conversion type k and window w is the same as the corresponding ratio for the overall conversion count. By making the assumption, it is no longer needed to make an assumption on the distribution of the underlying true conversions. Instead of using 1PC data to determine the truncated every, the Event API output is used, bypassing the dependence on 1PC data, which may not be used. The probability P(N_{kw}=n), n=0, 1, 2, 3 cannot be directly estimated from the event API output, but probability P(N=n), n=0, 1, 2, 3 can be directly determined without assuming distribution of true conversions.

Truncation happens because of the data collection limit applied on the generation of event API reports. The way of detecting truncation window can be different according to different prioritization strategies. For reports without conversion prioritization, the data collection (MPC) limit is applied based on conversion time across all reporting windows. To detect the truncation window for the case, the last reporting window with conversion reports would be the truncation window. For reports with conversion biddability prioritization, the MPC limit is applied based on the conversion biddability added to conversion time across each reporting window. The truncation windows can be split into 6 buckets for 3 reporting windows cases and 2 buckets for 1 reporting window. Each window can have biddable and non-biddable buckets. It is determined whether the truncation happens in biddable buckets or non-biddable buckets. If the current truncation window has non-biddable conversions, the truncation happens at the non-biddable bucket. (non-biddable>0). If the current truncation window only has biddable conversions, then the truncation happens at the biddable bucket. (non-biddable=0)

Parameters for each event are determined based on the truncated windows (510). The truncation window is used to estimate parameters for each event and apply debiasing formulas for the event API data. For each event i, each window w, and conversion type k, compute the expected conversion count on the true branch is determined by applying a set of selection criteria:

$$If {y}_{i} = ω ∈ \text{?} , then {\hat{t}}_{ikw} - {y}_{ikw}$$

$$If {y}_{i} = ω ∈ \text{?} , then {\hat{t}}_{ikw} - {μ}_{ikw}$$

$$If {y}_{i} = ω ∈ \text{?} , then {\hat{t}}_{ikw} = μ ( {N}_{kw} \geq n ) , n = 0 , 1 , 2 , 3$$

$$\text{?} \text{indicates text missing or illegible when filed}$$

The expected conversion count of each conversion type k and window is:

$$w : {\hat{n}}_{ikw} ( {y}_{i} ) = P ( True \vert {y}_{i} ) \times {\hat{t}}_{ikw} + P ( Fake \vert {y}_{i} ) \times {μ}_{kw}$$

The input data for event API debiasing layer can be event API data, event API configurations, interactions data from joined logs, aggregated API data. The input data can be used to estimate parameters for debiasing the event data.

The example process 500 presents multiple advantages. One advantage is that mild assumptions are applied for the distribution of true conversions (e.g., there is no need to assume a Poisson distribution). The example process 500 utilizes information from the event-level API, the Aggregate-level API, and the interaction event log without relying on any other data sources (e.g., 1PC data). The example process 500 can be applied when the coverage of 1PC tracking is low, non-existent, or even deprecated in the future. Robust to Config Changes: The example process 500 is applicable to any configuration, regardless of the particular choice of parameters (b, c, w, p). Even if the applied noise changes the parameters in the future or different parameters can be provided for different service providers (e.g., advertisers), the example process 500 remaining valid. As P is applied uniformly to all interaction events, noise P(Fake|y) can be estimated at a more granular level such as the campaign or iad-group level as long as they have a reasonably large number of interaction events. As a result, increases in P can have a relatively small impact on the estimation. noise. The example process 500 no longer relies on the aggregate API data to estimate P(Fake|y), and increasing the noise level of the aggregate API data has no iimpact on the estimation. As a result, high noises become tolerable, and browsers can achieve a better privacy guarantee while maintaining reasonable utility of the data. Simple and Cohesive: The example process 500 greatly reduces the complexity of computing P(Fake|y) and naturally matches the debiased event-level conversion count with ithe debiased aggregate-level count, which can simplify the original design of the Newton common data layer by incorporating the step of merging the debiased data from the two APIs. The example process 500 can be enhanced by the metadata filter: Identifying invalid metadata for each CTID allows identification of interaction events on the fake branches to improve the signal-noise ratio and obtain even more accurate estimates.

FIG. 6A is a block diagram of example event level API input data 600A, according to some implementations of the present disclosure. Data coming from the event-level reports is “event-level” in the sense that a record for each interaction is received and paired with metadata corresponding to the subsequent conversion(s). The example event level API input data 600A can be 3PC affirmative action data that forms the input into the API. In FIG. 6A, the series of boxes on the left represent interactions (e.g., interaction-views), and the series of boxes on the right represent conversions that may or may not occur following a presentation (display) of the interaction by a client device. The example event level API input data 600A includes 15 interaction-events depicted (view IDs: 1-15 602A-602E). The interaction-events are corresponding to several interaction-event features such as which campaign and interaction-group they correspond to.

As illustrated in FIG. 6A, the series of boxes on the left can include multiple campaigns 604A-604E and interaction-groups 606A-606E (2 campaigns and 3 interaction-groups). Conversions have their own metadata such as conversion type 608A-608G (e.g., sale or purchase) and conversion value 612A-612G (in $). If conversions occur, they are attributed to the corresponding interaction-view. Each of the views and conversions has complete metadata, in that all information is known about each piece. For example, the second view came from a particular campaign 610A-610G (e.g., Campaign 1, interaction-group 2, and resulted in 2 conversions), each of which were sale (purchase) events and totaling for $10 in value. The example event level API input data 600A includes multiple views which are not corresponding to any conversions, as indicated by the lack of conversions for views 4-15. The event-level reports are generated by APIs that use as input the described information, but only report a transformed version of the data back to the content provider system, as described with reference to FIG. 6B.

FIG. 6B is a block diagram of an example event level report 600B, according to some implementations of the present disclosure. The example event level report 600B can be generated by APIs that truncate event level API input data and the respective metadata (e.g., example event level API input data 600A, as described with reference to FIG. 6A).

For example, the view ID: 1 602A-602C truly had 4 attributed conversions, but the Event-level Reports report only includes 1. Also, the series of boxes on the right representing conversions do not have all the information about the conversions, but only that the conversion fell into “bucket 0” (the definition of a “bucket” being under the control of the content provider system.) On the other hand, unlike conversions, on which metadata is curtailed, the complete metadata can be retained and mapped to the example event level report 600B. In the example shown in FIG. 6B, the API is correctly presenting where conversions did not happen-namely on views 4-15.

For the example event level report 600B, at most 3 conversions may be registered against an interaction-click; and at most 1 conversion may be registered against an interaction-view. In the example event level report 600B “View ID: 1” is shown as including only 1 conversion while in reality 4 conversions were included in the event data. The example event level report 600B is less susceptible to truncation, suggesting that blending the two reports can be a promising approach to “filling-in” such truncation gaps in a post-processing step. The data from event-level reports is granular being a useful property for accurate conversion attribution. To preserve privacy, the granular attribution is subject to noising. Statistically, the noising is achieved via a randomized response mechanism. The randomized response mechanism implemented in the example event level report 600B involves a binary selection process with two distinct possibilities: (1) factual conversion activity is reported, or (2) random conversion activity is reported.

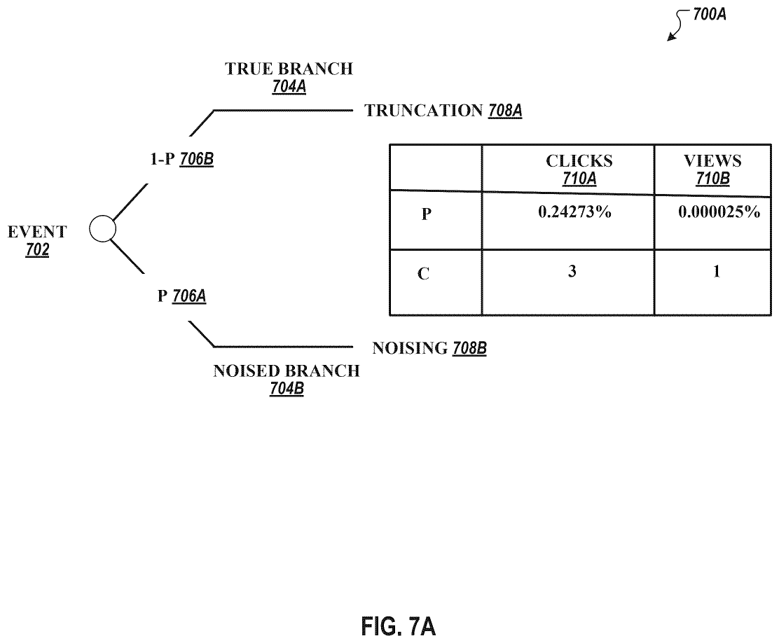

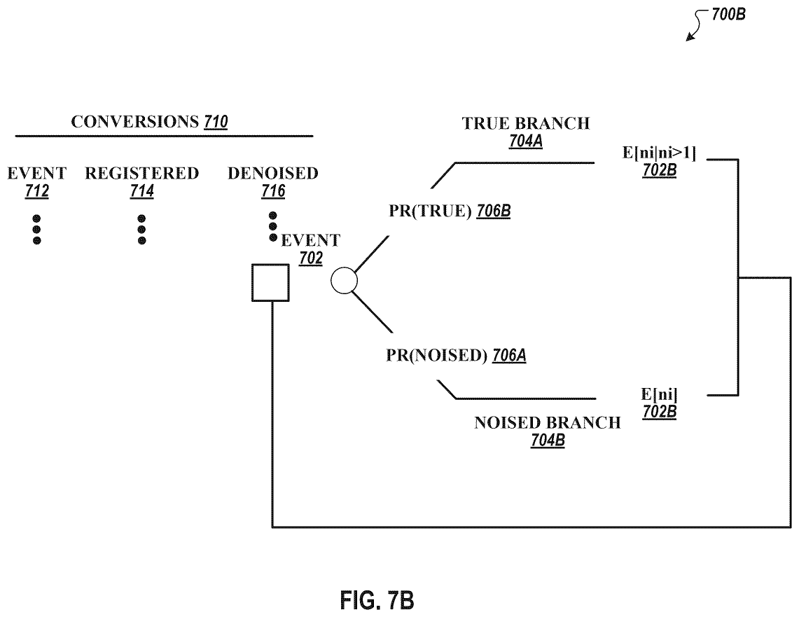

FIG. 7A are a block diagram showing an example of true and noise branch differentiation mechanism 700A, according to some implementations of the present disclosure. The branch differentiation mechanism 700A is presented using the example event level report 600B described with reference to FIG. 6B.

For each event 702 (interaction), it can be randomly selected which of the two branches to use with some probability. The true and noise branch differentiation mechanism 700A includes A classification between the “true branch” 704A and the “noised branch” 704B. The probability 706A of any given interaction landing on the noised branch is small and the probability 7068 of any given interaction landing on the true branch is high.

The event-level reports use a randomized response model. Given a fixed value p 706A, the event-level reports implement randomized response by randomly selecting each registered interaction-event 702 to be on the true branch 704A or the noised branch 704B with probability p 706A, 706B (note: p is known to content provider systems, but whether an interaction-event in the event-level reports is on the true branch or not is not known to content provider systems).

If the interaction-event 702 is on the true branch 704A, the number of conversions reported by the event-level reports are truncated 708A to the first c conversions and the metadata of such conversions are also limited-only some bits of metadata can be encoded and revealed to the content provider system. Also, the exact conversion time is not shown and is bucketed into time-windows corresponding to a number of clicks 710A and views 710B. The API can send conversion reports containing such information to content provider systems.

If an interaction-event 702 is on the noised branch 704B, the information of any true conversions or lack of conversions is suppressed by noise 708B and instead the API can randomly draw from a pool of possible configurations (a configuration is a specific realization of a conversion outcome) and produce conversion reports that are similar to those on the true branch 704A. As a result, content provider systems cannot tell whether conversion reports sent from the API are on the true branch 704A or the noised branch 704B.

FIG. 7B is a diagram of an event-debiasing mechanism 700B, according to some implementations of the present disclosure.

The event-debiasing mechanism 700B uses a debiasing transformation (essentially a function) that leverages the information from the API and produces an unbiased estimate of the true conversion count E[nᵢ]. Parameters are estimated for being used to obtain data-based “summary statistics” that form an input to the debiasing transformation. The debiasing transformation constructs an estimator four the conversions corresponding to each ad-event i in the Event-level Reports as follows:

$${\hat{n}}_{i} = E [ {n}_{i} \vert {y}_{i} ] = Pr ( True \vert {y}_{i} ) \times E [ n \vert \text{?} True ] + Pr ( Noised \vert {y}_{i} ) \times E [ {n}_{i} \vert \text{?} Noised ]$$

$$\text{?} \text{indicates text missing or illegible when filed}$$

The terms “noised branch” and “true branch” refer to whether the event, to which conversions are attributed to by the API, are on the noised or true branches. P (Noised branch) refers to a probability an event is on the noised branch 704B equivalently for the true branch 704A. Each event is allocated into a noised branch 704B or a true branch 704A with some probability.

At the time of event-denoising, y registered conversions 714 corresponding to events i 712 are included in event-level reports. To estimate the true conversions for an event i 712, the realization of y registered conversions 714 is condition to determine both the probability that an i event is on the noised branch 704B or a true branch 704A of the API, and what its true conversions can be. In the binary randomized response of the event-level reports, each interaction-event 712 is either on the noised branch 704B or a true branch 704A, but the exact state is unknown to content provider systems. The event 702 has a probability of being on the true and noised branch—Pr(True|y) and Pr(Noised|y).—The events i 712 can be determined using the y registered conversions 714 (based on the conditional probabilities on the branches following i the orange circle). Trivially, estimating one conditional probability gives the other as Pr (True|yᵢ)+Pr (Noised|yᵢ)=1.

The estimates of conversions on each branch are determined. If the interaction-event is on the noised branch, there is no relevant information from the API and the best estimate of the number of conversions given the event on the noised branch 704B is just E[nᵢ], the average conversion rate (again to be estimated). If the interaction-event is on the true branch, the conversions from event i are recognized as being truncated given that the event-level reports report at most 1 conversion following a view. Given an event is on the true branch,

$$E [ {n}_{i} \vert {y}_{i} ] = E [ {n}_{i} \vert {n}_{i} \geq 1 ] .$$

Using the denoising transformation formula for interaction-views can be used to generate the denoised event data. The case for interaction-clicks (described with reference to FIGS. 6A and 6B) can be processed the same except for the term E[nᵢ|yᵢ]. For the given example, at most 3 conversions can be reported for clicks: if yᵢ<3 from the event-level reports, it can be determined that conversions for event i have not been truncated, and E[nᵢ|yᵢ]=y can be used in the true branch formula. If y≥3 in the event-level reports, truncation of conversions for i event i may have occurred and the true branch formula E[nᵢ|yᵢ]=E[nᵢ|nᵢ≥3] can be used.

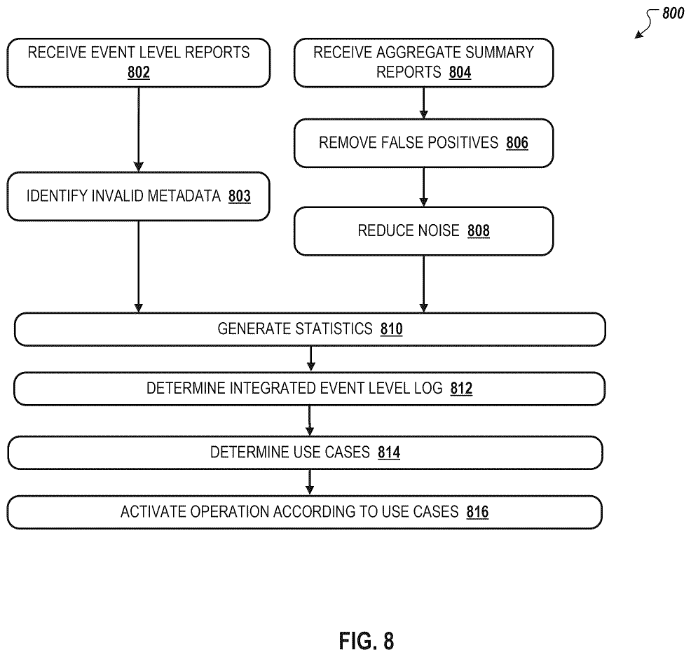

FIG. 8 is a flowchart illustrating an example process 800, according to some implementations of the present disclosure. The example process 800 can be executed using any component of the example system 100 described with reference to FIG. 1 or example system 200 described with reference to FIG. 2. Operations of the process 800 are described below for illustration purposes only. Operations of the process 800 can be performed by any appropriate device or system, e.g., any appropriate data processing apparatus. Operations of the process 800 can also be implemented as instructions stored on a computer readable medium which may be non-transitory. Execution of the instructions causes one or more data processing apparatus to perform operations of the process 800.

Event level reports (e.g., example event level data 600B described with reference to FIG. 6B) are received and processed, by a computing device from APIs of client devices (802). The event level reports include filtered interaction event data corresponding to interaction-events generated according to multiple conversion types that can be reported in a truncated format, as described with reference to FIGS. 6A and 6B. Data included in the event-level reports can be paired with metadata corresponding to the respective conversion(s). To protect user privacy, the API does not return the event-level data with full fidelity. A small proportion of ad-interactions are randomly chosen by the API to be assigned random conversion metadata. In some implementations, limits can be set on how much metadata can be extracted from the conversions.

The event level reports are processed to identify invalid metadata to remove events are determined to be on a fake branch (803). The event level reports can be processed using a metadata filter applied by a metadata mapping engine (e.g., metadata mapping engine 214 described with reference to FIG. 2A). The events in the event level reports can be filtered based on metadata entries that can be mapped to the events. If the metadata for an identified log entry is not registered inside the metadata mapping table, it is determined that the conversion (configuration) of the log entry is on the fake branch, the respective metadata is identified as being invalid for each conversion type identifier (CTID) that facilitates identification of interaction events on the fake branch. The interaction events on the fake branch can be reduced to improve the signal-noise ratio and obtain higher accurate estimates. The invalid events feature 3-bit conversion metadata (or 1-bit for EVC/VTC) not registered by a given CTID (see Identify clicks on the fake branch for more information). Invalid interaction events can be reduced from the event level reports. For events that were not certainly identified as being on the fake branch, the probability P(Fake|yᵢ) of each event of being on the fake branch is estimated. The processing can also include debiasing, as described with reference to FIG. 5.

Aggregated summary reports are received and processed, by one or more processors of a computing device (e.g., the server system 102 described with reference to FIG. 1 or the secure distribution system 202 described with reference to FIG. 2) from APIS of client devices (e.g., the client device 104, 204 described with reference to FIGS. 1 and 2) (804). The aggregated summary reports include data aggregates. The data aggregates include grouping of event-attributed affirmative action data that is aggregated to a slice level. The aggregated summary reports are configured based on a pre-definition of the slices over which an interaction provider system plans to learn about conversion activity. The processing can include denoising, as described with reference to FIG. 3.

The first step to merging the Event-Level and Aggregated summary Reports is to estimate better aggregates from the noisy data that the Aggregated summary Reports sends the content provider system. The step is essentially about reducing the impact of noise and is implemented by “post-processing” the aggregated summary report data. Post-processing is motivated by the following fact: If aggregates are used as a form of calibration of the event-level report data, it is important to ensure that those aggregates are as accurate as possible. For obtaining improved aggregates from post-processing, two important components are highlighted: dealing with “false positives” and leveraging the hierarchical nature of the aggregates. “False positives” in the aggregated summary reports one major way in which statistical noise in the aggregated summary reports affects the quality of the data is via “false positives.” False positives are aggregate slices without conversions in reality, but for which the aggregated summary reports add Laplace noise to 0 in its results. The results in slices that appear to have conversions when in actuality they do not.

The false positives are identified and reduced (806). The “false positives” can be determined by leveraging the hierarchical nature of the aggregated summary reports. The hierarchy of the aggregated summary reports facilitates efficient and flexible processing of the aggregated summary reports for identification of use cases. The “hierarchical” structure includes end arrangement of aggregates in a tree-like structure, where parent nodes “leaves” are split into child nodes “leaves” with each additional key. The hierarchy of the aggregated summary reports includes aggregate slices corresponding to parent event nodes and children event nodes, wherein unrelated branches including one or more nodes can correspond to false positive events. False positives are a consequence of the structure aggregated summary reports, wherein the keys on the basis of which aggregation has to be done by the ARA are used to be pre-registered by the content provider system before the data have arrived at the content provider system. Under the setup, content provider systems can register aggregate keys which may have conversions, but are not guaranteed to, leading to a large number of key-values including false positives. The false positive events are aggregate slices that are determined to have been artificially added to the aggregated summary reports without being related to any conversions of true user interactions. The results in aggregate slices that falsely appear to include conversions define false positives that are identifiable based on the structure of the aggregated summary reports. The structure schema (aggregation keys) used for aggregations can be stored in a database (e.g., the digital component repository 212, described with reference to FIG. 2). For example, the ARA used to generate the aggregation structure can be pre-registered by the content provider system (e.g., the content provider system 106, 206, described with reference to FIGS. 1 and 2) before the aggregated summary reports are received. In some implementations, the content provider systems can register multiple aggregate keys that can be used for conversions. False positive identification can include processing the aggregated summary report using each of them aggregation keys that are being stored. In response to identifying false positives representing error-filled aggregates in the configured aggregated summary reports, the false positives are reduced from the data. A variety of techniques can be implemented to filter out false positives. In some implementations, the event-level reports can be used to reduce false positives. For example, if click-through conversion (CTC) setting is considered, each click can register a triplet of conversions, each corresponding to a triplet of bits of metadata, over three-time windows. If a click is indicated in the aggregated summary reports that resulted in a conversion but was reported by the event-level reports as having no conversions, the respective click can be a false positive on a noised branch. Identifying an entry of the configured aggregated summary reports as being on a noised branch, the entry can be randomly attributed to the single bucket with no conversions. If the probability of the entry determined to be a false positive exceeds a set threshold (e.g., the chance of the entry to be corresponding to some true conversions, is below an acceptable threshold), the aggregate slices including false positives are reduced, helping to improve data quality.

The noise is determined and reduced to generate raw aggregated summary reports are generated (808). The noise identification procedure can be based on the hierarchical structure of the configured aggregated summary reports. Noise is added to the aggregate data, but the nature of the noise is different than in the event-level reports described with reference to FIGS. 5-7. Whereas the event-level reports use a local-differential privacy (DP) model for adding noise, the differential privacy mechanism in the aggregated summary reports is a central-DP model. Local-DP means that each interaction is subject to noise; central-DP means that noise is only added after some aggregation has occurred. As a difference to the noising mechanism in the event-level reports (randomized response), the aggregated summary reports use a Laplace noising mechanism. The noise added using Laplace noising mechanism includes a random variate from a Laplace distribution that is added to the aggregates. For example, event-level attributed conversions following interaction-events are truncated by the contribution bound; the truncated conversions are aggregated to a slice-level; and Laplace noise is added to that aggregate slice and reported. The aggregated summary reports use no specific structure nor a predefined set of keys over which to aggregate; those decisions are left up to the content provider system. The magnitude of the noise added to the aggregates is technically fixed, drawn from a Laplace distribution with mean 0 and standard deviation 2L1/ϵ, where L1 and ϵ are respectively the sensitivity of the data and the intended privacy level. The noise can be reduced from all slices of the aggregated summary reports. Statistical distribution of data can be determined to identify potential noise. For example, a particular entry type (e.g., campaign-level) aggregate can be compared with the sum of conversions across all interaction-groups in the respective entry type (campaign). If the comparison indicates that the measurements correspond to approximately the same quantity, the entry type aggregates in “A” can combined with the aggregates in the sum of conversions across all interaction-groups in the respective entry type “B”+“C” to improve the estimate of the quantity. In some implementations, Laplace noise that is centered at 0 and was added additively to the aggregated summary reports can be reduced by taking linear weighted averages of “A” and “B”+“C”, which would represent an unbiased estimate of the number of conversions. Another example approach for reducing noise is applying a skewed weighted average, which minimizes the final variance of the parent node estimate. The result is an improved estimate of the conversion count included in the configured aggregated summary report. Note that the skewed weighted average approach can include a second “top-down” pass to pass information down the tree, ultimately benefiting the most granular aggregates. The top-down approach looks at the difference between a slice and its children and distributes the difference across the child nodes. The described noise removal process provides “consistency” in that each slice's conversion count is exactly equal to the sum of its children; wherein raw API outputs do not share the property. The probabilities determined from the event-level reports for each event (e.g., a click) as having no conversions, can be used to remove aggregate slices, which the event-level reports indicate as not having conversions (configuration changes). The usage of the event-level reports in combination with aggregated summary reports helps improve data quality.

Statistics are generated by merging the debiased event level reports and denoised aggregation summary reports (810). In response to determining that the noise was reduced from the aggregates by post-processing the aggregated summary report data, the denoised aggregates can be used to post-process the event-level report data and create a unified, more accurate eventified log for various use-cases. The eventification can include bidding based on training of machine learning models using conversions (or conversion values) as labels and with interaction-event characteristics as features. The training of machine learning models uses as input a training dataset with units of interaction-events and attributed conversion (or conversion values) combinations, matching the structure of the eventified logs. Building both the reporting and the bidding off the same log can reduce processing complexity and automatically provides consistency across use-cases. For example, a training system can be used to train a machine learning model on the denoised aggregates and the event-level report data to predict values for the eventified log, resulting in a trained model. The conversions (or conversion values) and can be provided to the training system as input features, and the interaction-event characteristics contain values can be provided to the training system as target outputs. The training system can pick the type of machine learning model to be trained, e.g., pick a predefined or default type of machine learning model, or analyze the input features and the target outputs to identify a type of machine learning model according to reports according to event scenarios. For example, types of machine learning models can include a gradient boosted trees model, a generalized linear model, a support vector machine, a decision tree model, or a neural network model, e.g., a multilayer perceptron (MLP). The machine learning models can be trained using machine learning training algorithms such as minimizing an error, computing a gradient, or performing backpropagation. In some implementations, the training system can use the metadata corresponding to denoised aggregates and the event-level report data to preprocess the values of the interaction-event characteristics to provide to the training system. For example, by using metadata that identifies the type of data for the values, the system can preprocess the values so that the training system can more accurately interpret the values. In other words, the training system can map the conversion values in the cell into encoded representations that can be provided as input features for the training of the machine learning model. For example, the system can convert each pair of denoised aggregates and the event-level report data to predict values for the eventified log in a format that the content provider system and/or the asset provider system can interpret, such as for use cases. The event-level data provided by the event-level report data can be processed for event denoising including identification of noising and truncation of conversions on these events. Each event in the event-level report data is transformed using the conversions reported by the event-level reports for that event by implementing a denoising transformation. The denoising transformation corrects both for the randomized response noising implemented by the event-level reports and the truncation it imposes on attributed conversions. The transformation is data-driven and takes as input a set of summary statistics that index key aspects of the underlying data generating process. The summary statistics are determined from the improved aggregates to obtain from the aggregated summary reports after post-processing.

An integrated event-level log that reports conversions attributed to each event that have been corrected for the noise and truncation of the event-level reports is generated (812). The correction leverages information from the aggregated summary reports by merging information from both API taking advantage of the information content of both event-level reports and aggregated summary reports. The integrated event-level log when aggregated can be consistent with the post-processed aggregates from the aggregated summary reports (which was not guaranteed to be the case with the raw event-level report and aggregated summary reports that are processed separate from each other, as described with reference to FIGS. 3 and 5).

Interaction use cases are determined for the integrated event-level log (814). For example, digital components associated to integrated event-level log derived from the raw aggregated summary reports merged with the debiased event data can be identified using data content mapping and obtained from a data base. The mapped digital components can be electronically stored in a physical memory device as a single file or in a collection of files, such as video files, audio files, multimedia files, image files, or text files and include service (e.g., testing or advertising) information, such that an interaction is a type of digital component. For example, the digital component may be content that is intended to supplement content of a web page or other resource presented by an application executed by a client device. More specifically, the digital component may include digital content that is relevant to the resource content (e.g., the digital component may relate to the same topic as the web page content, or to a related topic). The provision of digital components can supplement, and generally enhance, the web page or application content providing access to an asset providing system.

A trigger to activate the operations of asset providing systems using interaction use cases is generated (816). The trigger can automatically activate execution of one or more operations corresponding to the determined interaction use cases. The operations can include establishment of a communication channel with the client devices, transmission of the digital components from the database to the client devices, and/or transmission offers corresponding to the digital component from asset providing systems to the client devices. The operations can include an automatic modification of a display of the client devices to increase a visibility of the automatically triggered display of the digital component.

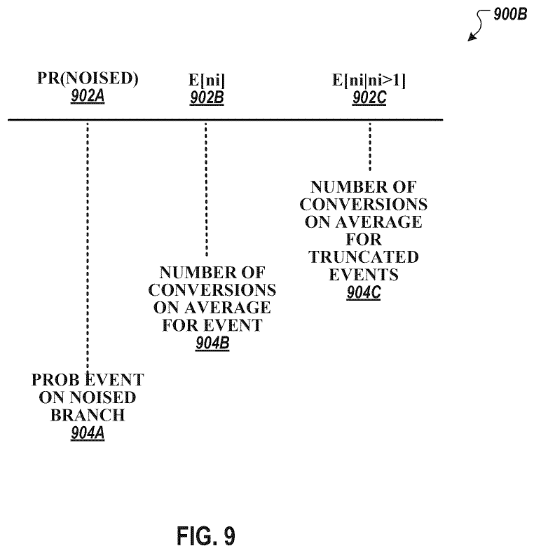

FIG. 9 is a diagram of an example mechanism 900 for parameter learning and blending with aggregated summary reports data, according to some implementations of the present disclosure. For example, the example mechanism 900 can be included in the example process 800 described with reference to FIG. 8.

The example mechanism 900 indicates an example implementation of a debiasing formula, using estimated summary statistics from the data. The debiasing formula defines that the key summary statistics are Pr(Noised|yᵢ), E[nᵢ], and E[nᵢ|nᵢ≥c] for different values of c. The summary statistics can be learned from a combination of the raw event-level report log and the post-processed aggregates. FIG. 9 illustrates the execution sequence.

Pr(Noised|yᵢ) 902A: is the probability an event 904A to be on the noised branch given that yᵢ conversions are reported by the event-level reports for a respective event. Objects can be determined directly from the event-level reports by leveraging our knowledge of the API mechanism. Both the noising probability and the way the noised branch configurations are drawn, it can be estimated the probability of each configuration to occur on the noised branch. The probability can be used to determine how likely each configuration actually occurs in the ad-tech's event-level report data. If a configuration occurs more often in the event-level report data than expected, from the noised branch, Pr(Noised|yᵢ) is small.

E[nᵢ] 902B: is the expected conversion rate 904B that can be estimated it by dividing the total conversion count obtained after post-processing the aggregates from the aggregated summary reports, by the count of ad-events registered with the event-level reports.

E[nᵢ|nᵢ≥c] 902C: uses a combination of both API reports. For example, if the event-level reports hypothetically only have a true branch and implements conversion truncation. Within the context example, the conversion count provided by the aggregated summary reports is accurate such that the count of conversions being truncated by the event-level reports can be determined by comparing the difference in the reported conversion count between the two API. An average 904C of how many conversions are being truncated for each truncated ad-event can be determined, estimating the object as E[nᵢ|nᵢ≥c] 902C. In general, the aggregated summary reports can be configured appropriately so that it provides a reasonable overall count; and can account for the noised branch in the event-level reports to account for the fact that the conversion count it reports is not fully accurate.

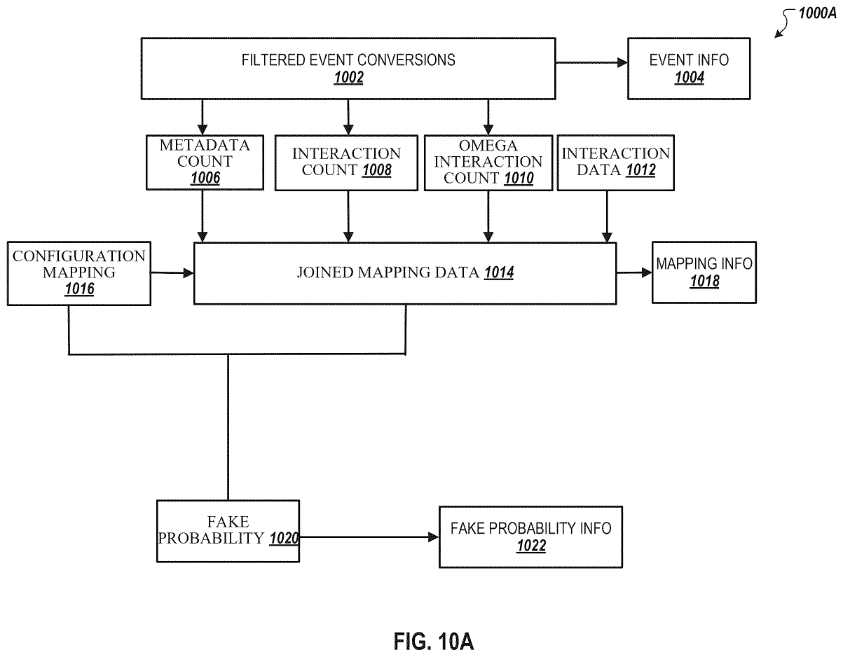

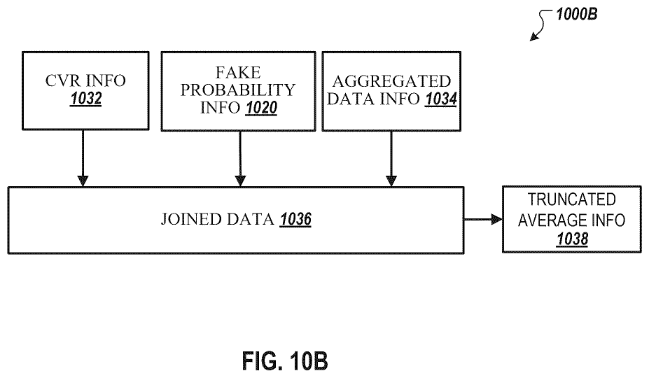

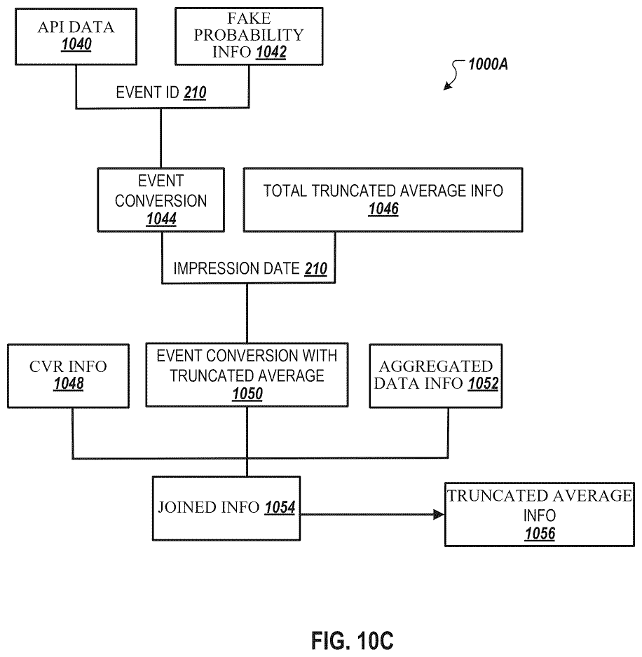

FIG. 10A is a diagram of example data flow to generate fake probability estimates, according to some implementations of the present disclosure. For example, the example mechanism 1000A can be included in the example process 800 described with reference to FIG. 8.

Filtered event conversions 1002 can be used to generate event information 1004, metadata count 1006, interaction count 1008, omega interaction count 1010, and interaction data 1012. The metadata count 1006, the interaction count 1008, the omega interaction count 1010, and the interaction data 1012 can be merged through joined mapping data 1014 using configuration mapping 1016 to generate mapping information 1018.

The joined mapping data 1014 can join aggregated data info with interaction data information to determine conversions using the following formula.

Cvr=aggregated_conversion_cnt<impression_date×CTID×conversion_metadata×delay_window>/aggregated_interaction_cnt<impression_date×CTID>

The conversion metadata: map relative to the conversion type and biddability can be used to generate conversion metadata using metadata mapping table.

A delay window including conversion date and impression date can be used as a join key to determine corner cases. For Ctid that are not inside aggregated data, like the unattributed interactions, set its Cvr to 0. If the aggregated conversion count is negative, set its CVR to 0. For aggregated conversions there are no interactions from Java Advanced Imaging (JAI), and the click count from event API data input can be processed to determine the fake probability 1020 that is used to generate the fake probability information 1020.

FIG. 10B is a diagram of example joining truncated average data mechanism 1000B, according to some implementations of the present disclosure. For example, the example mechanism 1000B can be included in the example process 800 described with reference to FIG. 8.

Conversion information 1032, fake probability information 1020, and aggregated data information 1024 can be used to derive joined data 1026 that can be used to determine truncated average information 1038. Calculating the truncated averages on each slice conversion metadata X delay window includes determining the total truncated averages and determining the sliced truncated averages. An example pseudocode for determining total truncated averages and determining the sliced truncated averages is included below.

The total truncated averages are calculated based on the following formula.

$$\begin{matrix}Conv = C ( \text{?} = 1 , True ) + C ( \text{?} = 2 , True ) \times 2 + C ( \text{?} \geq 3 , True ) \times \\ μ ( \text{?} \geq 3 ) + C ( Fake ) \times μ \\ 1. C ( \text{?} \geq 3 , True ) = 0 or C ( \text{?} \geq 2 , True ) = \text{?} because there are \\ no clicks with 3 or 2 reported conversions \text{?} \\ Note : This will require updating the fake probability for all \\ clicks on these slices \text{?} \\ 2. C ( \text{?} \geq 3 , True ) > 0 , and Conv < C ( \text{?} = 1 , True ) + C ( \text{?} = \\ 1 , True ) + C ( \text{?} = 2 , True ) \times 2 + C ( Fake ) \times μ because the \\ aggregate conversion counts are to small \text{?} \\ 3. The calculated results leads to μ ( \text{?} \geq 3 ) < 3 , or \\ μ ( \text{?} \geq 2 ) < 2 \text{?} or μ ( \text{?} \geq 1 ) < 1 \text{?}\end{matrix}$$

$$\text{?} \text{indicates text missing or illegible when filed}$$

```
// Pseudo code
Void GetTotalTruncatedAverages(CvrInfo, FakeProbabilityInfo, AggregatedDataInfo) {
  Double sum_cvr = Sum(cvr_info.cvr( ));
  Double sum_fake_conv = 0;
  // This is the click counts with n reported conversions
  std::vector<double> sum_clicks(config.mpc_limit( ), 0.0);
  // Calculate the sum of fake probabilities on the impression date × ctid.
  // Calculate the sum of true probabilities of clicks with n reported conversions
  for (const fake_prob: fake_prob_info) {
    double fake_probability = fake_prob.fake_probability( );
    sum_fake_conv += fake_probability * sum_cvr;
    sum_clicks[api_conv_all_windows_per_event − 1] += 1 · fake_probability;
  }
  Double sum_agg_data = sum(agg_data.aggregated_count( ));
  μ(N ≥ 0) = sum_cvr;
  μ(N ≥ 1) = MAX((sum_agg_data − sum_fake_conv) / SUM(sum_clicks[0] + sum_clicks[1] +
sum_clicks[2], 1);
```

FIG. 10C is a diagram of example joining truncated data mechanism 1000C, according to some implementations of the present disclosure. For example, the example mechanism 1000C can be included in the example process 800 described with reference to FIG. 8.

API data 1040 and fake probability information 1042 are merged for determining event conversion 1044. Total truncated average information 1046 are used to generate event conversion with truncated average 1050. The event conversion with truncated average 1050 can be used with the conversion information 1048 and the aggregated data information 1052 to generate joined information 1054 that can be processed to determine truncated average information 1056 using the following formula for conversion:

$${Conv}_{kw , agg} < {Conv}_{kw , untrunc} ( True ) + {Conv}_{kw , ptrunc} ( True ) + {Conv}_{kw}$$

(Fake), if the aggregate count on the sliced level is too small, the truncated averages can be kept as what they are.

An example pseudocode for joining truncated data is included below.

```
// Pseudo code
void GetSlicedTruncatedAverages(ProcessedEventApiConversion, CvrInfo,
FakeProbabilityInfo, AggregatedDataInfo) {
  double sum_fake_convs = 0.0, sum_untrunc_convs = 0.0, sum_btrunc_convs = 0.0,
sum_ptrunc_convs = 0.0;
  std::vector<double> sum_clicks_with_n_reports_or_more(config.mpc_limit( ) + 1, 0.0;
  // Get the vars needed for calculating truncation
  averages for (const event_conv : event_convs) {
    double fake_prob = event_conv.fake_prob( );
    NextonDelayAnnotation delay_annotation = event_conv.delay_annotation( );
    sum_fake_convs += fake_prob * cvr;
    // no truncation happen, below ‘api_conv_all_windows_per_event < mpc_limit‘ is the
condition for event api data without prioitization
// Pseudo code
void GetSlicedTruncatedAverages(ProcessedEventApiConversion, CvrInfo,
FakeProbabilityInfo, AggregatedDataInfo) {
  double sum_fake_convs = 0.0, sum_untrunc_convs = 0.0, sum_btrunc_convs = 0.0,
sum_ptrunc_convs = 0.0;
  std::vector<double> sum_clicks_with_n_reports_or_more(config.mpc_limit( ) + 1, 0.0);
  // Get the vars needed for calculating truncation
  averages for (const event_conv : event_convs) {
    double fake_prob = event_conv.fake_prob( );
    NextonDelayAnnotation delay_annotation = event_conv.delay_annotation( );
    sum_fake_convs += fake_prob * cvr;
    // no truncation happen, below ‘api_conv_all_windows_per_event < mpc_limit‘ is the
condition for event api data without prioritization
```

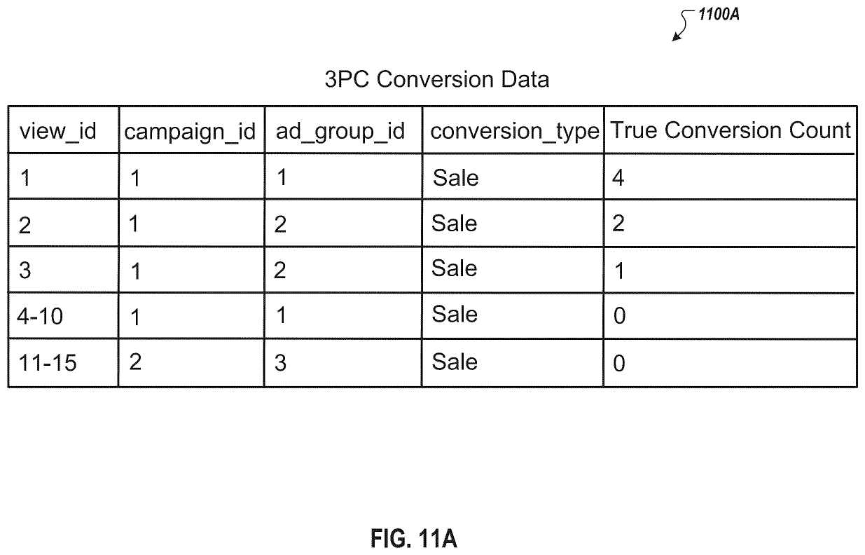

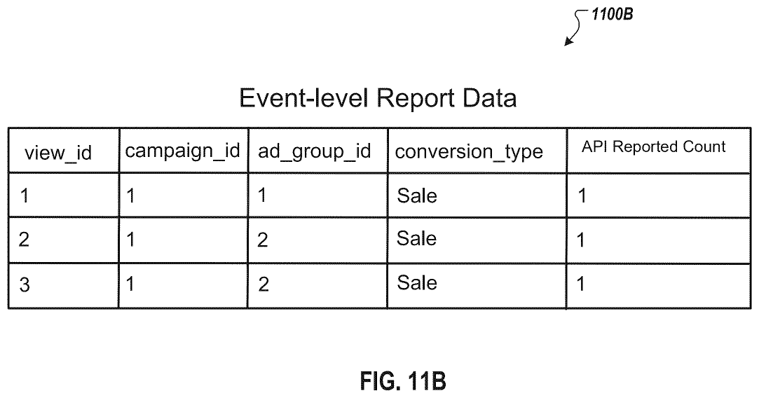

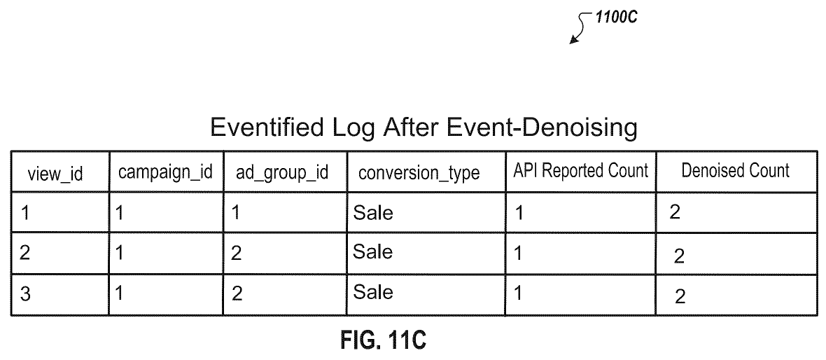

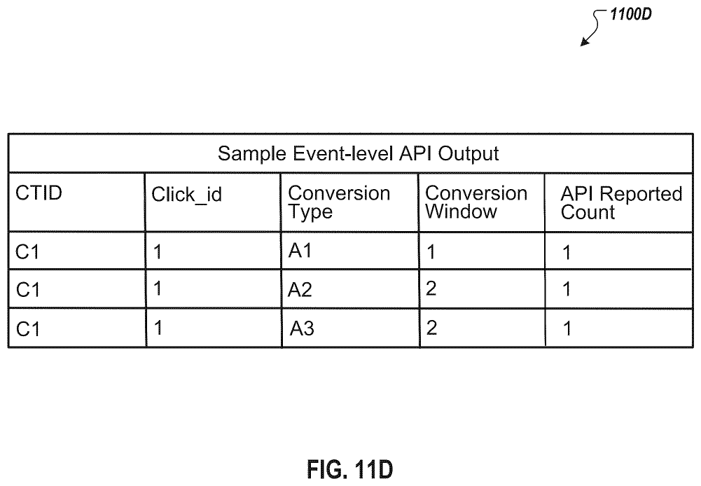

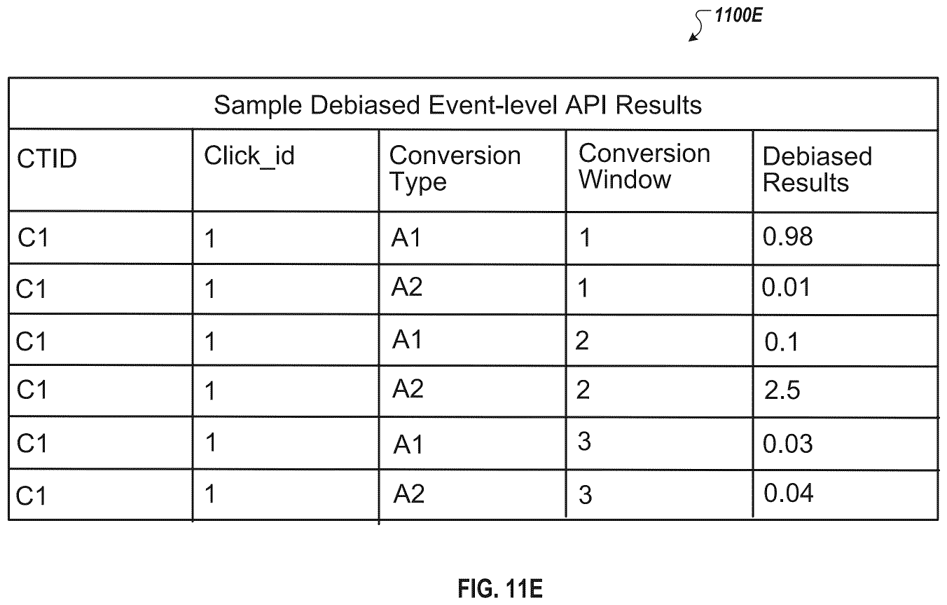

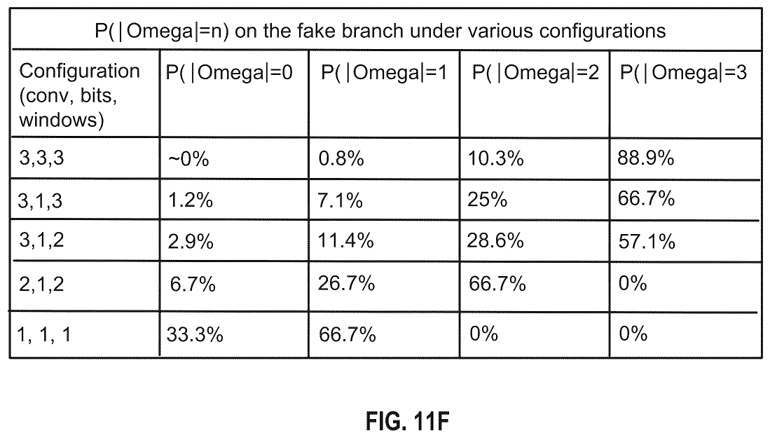

FIG. 11A is an example of 3PC affirmative action data 1100A, according to some implementations of the present disclosure.

FIG. 11B is an example of event level report data 1100B, according to some implementations of the present disclosure.

FIG. 11C is an example of eventified log after event denoising data 1100C, according to some implementations of the present disclosure.

FIG. 11D is an example of event level application programing interface output data 1100D, according to some implementations of the present disclosure.

FIG. 11E is an example of debiased event level application programing interface result data 1100E, according to some implementations of the present disclosure.

FIG. 11F is an example of probability estimates on fake branches 1100E, according to some implementations of the present disclosure.

In some implementations, components of the environments and systems described above may be any computer or processing device such as, for example, a blade server, general-purpose personal computer (PC), Macintosh®, workstation, UNIX®-based workstation, or any other suitable device. In other words, the present disclosure contemplates computers other than general purpose computers, as well as computers without conventional operating systems. Further, components may be adapted to execute any operating system, including Linux®, UNIX®, Windows®, Mac OS®, Java™, Android™, iOS® or any other suitable operating system. According to some implementations, components may also include, or be communicably coupled with, an e-mail server, a web server, a caching server, a streaming data server, and/or other suitable server(s).

Processors used in the environments and systems described above may be a central processing unit (CPU), an application specific integrated circuit (ASIC), a field-programmable gate array (FPGA), or another suitable component. Generally, each processor can execute instructions and manipulates data to perform the operations of various components. Specifically, each processor can execute the functionality used to send requests and/or data to components of the environment and to receive data from the components of the environment, such as in communication between the external, intermediary and target devices.

Components, environments and systems described above may include a memory or multiple memories. Memory may include any type of memory or database engine and may take the form of volatile and/or non-volatile memory including, without limitation, magnetic media, optical media, random access memory (RAM), read-only memory (ROM), removable media, or any other suitable local or remote memory component. The memory may store various objects or data, including caches, classes, frameworks, applications, backup data, objects, jobs, web pages, web page templates, database tables, repositories storing entity information and/or dynamic information, and any other appropriate information including any parameters, variables, algorithms, instructions, rules, constraints, for references thereto corresponding to the purposes of the target, intermediary and external devices. Other components within the memory are possible.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. Software may instead include a number of sub-engines, third-party services, components, libraries, and such, as appropriate. Conversely, the features and functionality of various components can be combined into single components as appropriate.

Devices can encompass any computing device such as a smart phone, tablet computing device, PDA, desktop computer, laptop/notebook computer, wireless data port, one or more processors within these devices, or any other suitable processing device. For example, a device may comprise a computer that includes an input device, such as a keypad, touch screen, or other device that can accept user information, and an output device that conveys information corresponding to components of the environments and systems described above, including digital data, visual information, or a graphical user interface (GUI). The GUI interfaces with at least a portion of the environments and systems described above for any suitable purpose, including generating a visual representation of a web browser.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of particular implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter the application discloses the following list of examples, wherein one feature of an example in isolation or more than one feature of said example taken in combination and, optionally, in combination with one or more features of one or more further examples are further examples also falling within the disclosure of the application. In some implementations, any of the following examples may be performed concurrently, individually, in parallel, and/or in combination with any other of the listed examples.

Example 1. A computer-implemented method comprising: receiving, from application programming interfaces, aggregated summary reports comprising aggregated event-data collected, by the application programming interfaces, during events corresponding to interactions with user interfaces, the aggregated event-data being aggregated using a hierarchical structure corresponding to a data type; removing a first portion of the aggregated event data identified as false positives from the aggregated summary reports to maintain true positive aggregated event data; reducing noise from the true positive aggregated event data, at each level of the hierarchical structure, to generate denoised aggregated summary reports; determining operations using the denoised aggregated summary reports; and providing, to an asset provider system, an instruction to activate at least one of the operations using the denoised aggregated summary reports. As described above, due to anonymization, aggregation, information truncation and addition of noise, the data reported to content provider systems by the API can deviate from the affirmative action data measured by third party cookies to preserve user privacy. The techniques applied to preserve user privacy are set by API configurations. Information derived from the API configuration settings are used to generate denoised aggregated summary reports. In contrast to the described example, third party cookie-based analysis of data may typically not facilitate such operations while in the noisy/privacy preserved state. The processing of aggregated event-data described in the present example includes removal of private information or replacement of private information with generic information that facilitates a statistical analysis based on the interaction data derived from the aggregated event-data, and in doing so, preserving user privacy. The denoised aggregated summary reports can be processed to generate interaction use case data without breaching privacy and security measures imposed by system privacy settings. In contrast to systems including third party cookies, where particular operations can be blocked as potentially presenting risks to the system security, the system privacy settings of the described example, facilitate transparency of operations and data processing, that enable automatic activation of the execution of one or more operations. The operations can include establishment of a communication channel with the client devices, transmission of the digital components from the database to the client devices, and/or transmission offers corresponding to the digital component from asset providing systems to the client devices. The operations can include an automatic modification of a display of the client devices to increase a visibility of the automatically triggered display of the digital component.

Example 2. The computer-implemented method of the preceding example, wherein the aggregated summary reports comprise hierarchically structured event-attributed configuration data as nodes distributed in a plurality of levels.

Example 3. The computer-implemented method of any of the preceding examples, wherein the event-attributed configuration data comprise truncated aggregated as data slices at one or more levels.

Example 4. The computer-implemented method of any of the preceding examples, wherein the noise comprises Laplace noise added to each of the data slices.

Example 5. The computer-implemented method of any of the preceding examples, further comprising: generating weighted averages of parent nodes and child nodes to minimize a variance of an estimate of a parent node.

Example 6. The computer-implemented method of any of the preceding examples, wherein processing the aggregated summary reports to reduce the noise comprises: applying a denoising transformation to correct both for randomized response noising implemented by the Laplace noise and the truncated data.

Example 7. The computer-implemented method of any of the preceding examples, wherein applying the denoising transformation comprises using a set of summary statistics that index aspects of a configuration type.

Example 8. The computer-implemented method of any of the preceding examples, wherein the aggregated summary reports comprise metadata corresponding to the configuration type applied to the structured event-attributed configuration data.

Example 9. A computer-implemented system comprising: memory storing application programming interface (API) information; and a server performing operations comprising: receiving, from application programming interfaces, aggregated summary reports comprising aggregated event-data collected, by the application programming interfaces, during events corresponding to interactions with user interfaces, the aggregated event-data being aggregated using a hierarchical structure corresponding to a data type; removing a first portion of the aggregated event data identified as false positives from the aggregated summary reports to maintain true positive aggregated event data; reducing noise from the true positive aggregated event data, at each level of the hierarchical structure, to generate denoised aggregated summary reports; determining operations using the denoised aggregated summary reports; and providing, to an asset provider system, an instruction to activate at least one of the operations using the denoised aggregated summary reports.

Example 10. The computer-implemented system of the preceding example, wherein the aggregated summary reports comprise hierarchically structured event-attributed configuration data as nodes distributed in a plurality of levels.

Example 11. The computer-implemented system of any of the preceding examples, wherein the event-attributed configuration data comprise truncated aggregated as data slices at one or more levels.

Example 12. The computer-implemented system of any of the preceding examples, wherein the noise comprises Laplace noise added to each of the data slices.

Example 13. The computer-implemented system of any of the preceding examples, wherein the operations further comprise: generating weighted averages of parent nodes and child nodes to minimize a variance of an estimate of a parent node.

Example 14. The computer-implemented system of any of the preceding examples, wherein processing the aggregated summary reports to reduce the noise comprises: applying a denoising transformation to correct both for randomized response noising implemented by the Laplace noise and the truncated data.

Example 15. The computer-implemented system of any of the preceding examples, wherein applying the denoising transformation comprises using a set of summary statistics that index aspects of a configuration type.

Example 16. The computer-implemented system of any of the preceding examples, wherein the aggregated summary reports comprise metadata corresponding to the configuration type applied to the structured event-attributed configuration data.

Example 17. A non-transitory computer-readable media encoded with a computer program, the computer program comprising instructions that when executed by one or more computers cause the one or more computers to perform operations comprising: receiving, from application programming interfaces, aggregated summary reports comprising aggregated event-data collected, by the application programming interfaces, during events corresponding to interactions with user interfaces, the aggregated event-data being aggregated using a hierarchical structure corresponding to a data type; removing a first portion of the aggregated event data identified as false positives from the aggregated summary reports to maintain true positive aggregated event data; reducing noise from the true positive aggregated event data, at each level of the hierarchical structure, to generate denoised aggregated summary reports; determining operations using the denoised aggregated summary reports; and providing, to an asset provider system, an instruction to activate at least one of the operations using the denoised aggregated summary reports.

Example 18. The non-transitory computer-readable media of the preceding example, wherein the aggregated summary reports comprise hierarchically structured event-attributed configuration data as nodes distributed in a plurality of levels, wherein the event-attributed configuration data comprise truncated aggregated as data slices at one or more levels, wherein the noise comprises Laplace noise added to each of the data slices.

Example 19. The non-transitory computer-readable media of any of the preceding examples, wherein the operations further comprise: generating weighted averages of parent nodes and child nodes to minimize a variance of an estimate of a parent node,

Example 20. The non-transitory computer-readable media of any of the preceding examples, wherein processing the aggregated summary reports to reduce the noise comprises: applying a denoising transformation to correct both for randomized response noising implemented by the Laplace noise and the truncated data, wherein applying the denoising transformation comprises using a set of summary statistics that index aspects of a configuration type, and wherein the aggregated summary reports comprise metadata corresponding to the configuration type applied to the structured event-attributed configuration data.

Example 21. A computer-implemented method comprising: receiving, from application programming interfaces, event level reports comprising branches defining records of events comprising interactions with the application programming interfaces, the event level reports being paired with metadata corresponding to configurations of the application programming interfaces; performing an identification of portions of the metadata comprising invalid metadata; classifying a portion of the events as being on true branches by estimating a probability of each of the branches to be true or noised using the identification of the portions of the metadata that comprise the invalid metadata; determining configuration parameters for the true branches, the configuration parameters comprising a number of configurations on average for each event; generating raw application programming interface data by applying a debiasing model using the configuration parameters by joining a plurality of reporting windows and configuration types; determining operations using the raw application programming interface data; and providing, to an asset provider system, an instruction to activate at least one of the operations using the raw application programming interface data. Addressing the limitations of event level deviations generated by third party cookies, the processing of event level data described in the present example facilitates a statistical analysis based on the interaction data derived from the event level data, while preserving user privacy. In particular, the current example describes a process of generating debiased data that includes a replacement of the truncated data with generic data that facilitates usage of the debiased data for statistical analysis. Another advantage of the present example is that the noise level of the aggregate API data (added as Laplace noise to data aggregates) has no impact on the estimation of interaction data based on the event level data. The noise added using Laplace noising mechanism includes a random variate from a Laplace distribution that is added to the aggregates. Event-level attributed conversions following interaction-events are truncated by the contribution bound, the truncated conversions are aggregated to a slice-level, and Laplace noise is added to that aggregate slice and reported. As a result, high noises of aggregated summary reports become tolerable being removed using a noise identification procedure based on the hierarchical structure of the configured aggregated summary reports. The described example provides a simple and cohesive process that by applying denoising strategies matching the API settings for generating the event level reports. Another advantage of the present example is that the process for generating debiased data can be enhanced by a metadata filter that is used for identifying invalid metadata that allows identification of interaction events on the fake branches to improve the signal-noise ratio and obtain even more accurate estimates. In contrast to the described example, the event level reports generated by third party cookies generally do not have a mapping to metadata indicative of a presence of an event usable for false event identification.

Example 22. The computer-implemented method of the preceding example, wherein the configuration parameters comprise a configuration count of each configuration type and a configuration window.

Example 23. The computer-implemented method of any of the preceding examples, further comprising: determining truncated averages as an expected total configuration count of the each configuration type and window when being truncated for each configuration type.

Example 24. The computer-implemented method of any of the preceding examples, determining truncated averages comprises: determining total truncated averages by aligning an aggregate configuration count with the application programming interface data using impression dates; and determining sliced truncated averages by aligning a total aggregate configuration count with the application programming interface data using the impression dates and delay window levels.

Example 25. The computer-implemented method of any of the preceding examples, wherein the total truncated averages comprise a total configuration count truncated at a number of configurations.

Example 26. The computer-implemented method of any of the preceding examples, wherein the total truncated averages comprise corner cases that are absent from event simulations and appear in the total aggregate configuration count.

Example 27. The computer-implemented method of any of the preceding examples, wherein the sliced truncated averages comprise truncation ratios per data slice.

Example 28. The computer-implemented method of any of the preceding examples, wherein estimating the probability of each of the branches to be true or noised comprises generating a ratio of total interactions count on an impression date obtained from interaction logs relative to total number of conditioning interactions.

Example 29. A computer-implemented system comprising: memory storing application programming interface (API) information; and a server performing operations comprising: receiving, from application programming interfaces, event level reports comprising branches defining records of events comprising interactions with the application programming interfaces, the event level reports being paired with metadata corresponding to configurations of the application programming interfaces; performing an identification of portions of the metadata comprising invalid metadata; classifying a portion of the events as being on true branches by estimating a probability of each of the branches to be true or noised using the identification of the portions of the metadata that comprise the invalid metadata; determining configuration parameters for the true branches, the configuration parameters comprising a number of configurations on average for each event; generating raw application programming interface data by applying a debiasing model using the configuration parameters by joining a plurality of reporting windows and configuration types; determining operations using the raw application programming interface data; and providing, to an asset provider system, an instruction to activate at least one of the operations using the raw application programming interface data.

Example 30. The computer-implemented system of the preceding example, wherein the configuration parameters comprise a configuration count of each configuration type and a configuration window.

Example 31. The computer-implemented system of any of the preceding examples, the operations further comprising: determining truncated averages as an expected total configuration count of the each configuration type and window when being truncated for each configuration type.

Example 32. The computer-implemented system of any of the preceding examples, determining truncated averages comprises: determining total truncated averages by aligning an aggregate configuration count with the application programming interface data using impression dates; and determining sliced truncated averages by aligning a total aggregate configuration count with the application programming interface data using the impression dates and delay window levels.

Example 33. The computer-implemented system of any of the preceding examples, wherein the total truncated averages comprise a total configuration count truncated at a number of configurations.

Example 34. The computer-implemented system of any of the preceding examples, wherein the total truncated averages comprise corner cases that are absent from event simulations and appear in the total aggregate configuration count.

Example 35. The computer-implemented system of any of the preceding examples, wherein the sliced truncated averages comprise truncation ratios per data slice.

Example 36. The computer-implemented system of any of the preceding examples, wherein estimating the probability of each of the branches to be true or noised comprises generating a ratio of total interactions count on an impression date obtained from interaction logs relative to total number of conditioning interactions.

Example 37. A non-transitory computer-readable media encoded with a computer program, the computer program comprising instructions that when executed by one or more computers cause the one or more computers to perform operations comprising: receiving, from application programming interfaces, event level reports comprising branches defining records of events comprising interactions with the application programming interfaces, the event level reports being paired with metadata corresponding to configurations of the application programming interfaces; performing an identification of portions of the metadata comprising invalid metadata; classifying a portion of the events as being on true branches by estimating a probability of each of the branches to be true or noised using the identification of the portions of the metadata that comprise the invalid metadata; determining configuration parameters for the true branches, the configuration parameters comprising a number of configurations on average for each event; generating raw application programming interface data by applying a debiasing model using the configuration parameters by joining a plurality of reporting windows and configuration types; determining operations using the raw application programming interface data; and providing, to an asset provider system, an instruction to activate at least one of the operations using the raw application programming interface data.

Example 38. The non-transitory computer-readable media of the preceding example, wherein the configuration parameters comprise a configuration count of each configuration type and a configuration window, the operations further comprising: determining truncated averages as an expected total configuration count of the each configuration type and window when being truncated for each configuration type.

Example 39. The non-transitory computer-readable media of the preceding example, determining truncated averages comprises: determining total truncated averages by aligning an aggregate configuration count with the application programming interface data using impression dates; and determining sliced truncated averages by aligning a total aggregate configuration count with the application programming interface data using the impression dates and delay window levels, wherein the total truncated averages comprise a total configuration count truncated at a number of configurations, wherein the total truncated averages comprise corner cases that are absent from event simulations and appear in the total aggregate configuration count.

Example 40. The non-transitory computer-readable media of any of the preceding examples, wherein the sliced truncated averages comprise truncation ratios per data slice, and wherein estimating the probability of each of the branches to be true or noised comprises generating a ratio of total interactions count on an impression date obtained from interaction logs relative to total number of conditioning interactions.

Example 41. A computer-implemented method comprising: receiving, from application programming interfaces, event level reports comprising a biased record of events comprising interactions with the application programming interfaces, the event level reports being paired with metadata corresponding to configurations applied by application programming interfaces; generating raw event level reports from the event level reports by applying a debiasing model using configuration parameters of the application programming interfaces to remove false events from the event level reports; receiving, from the application programming interfaces, aggregated summary reports comprising an aggregated record of the events corresponding to the interactions with the application programming interfaces included in the event level reports; generating raw aggregated summary reports from the aggregated summary reports by using metadata mapping to remove false positives events from the event level reports; generating statistical data by matching the raw event level reports to the raw aggregated summary reports according to event scenarios; determining operations using the statistical data; and providing, to an asset provider system, an instruction to activate at least one of the operations using the statistical data. In contrast to interaction data reports generated by third party cookies that are generally of a single type, the technology described in this example includes an integration protocol of two types of interaction data reports: event-level and aggregated summary reports. The integration protocol of two types of interaction data reports, providing an advantage of facilitating an interaction-measurement with high utility without breaching privacy and security measures imposed by system privacy settings. In particular, the described example leverages information from both event-level reports and aggregated summary reports. The integrated event-level log when aggregated can be consistent with the post-processed aggregates from the aggregated summary reports, which was not guaranteed to be the case with the raw event-level report and aggregated summary reports that are processed separate from each other, as described with reference to Example 1 and Example 21. The generation of statistical data by merging event-level data and aggregated summary reports increases an accuracy of the interaction measurements, by leveraging the combined use of the API data that provides better measurement fidelity than using either report type in isolation.

Example 42. The computer-implemented method of the preceding example, wherein the biased record of events comprises anonymization, aggregation, information truncation and noise infusion to interaction data to protect a privacy of users performing the interactions with the application programming interfaces.

Example 43. The computer-implemented method of any of the preceding examples, wherein the aggregated summary reports comprise hierarchically structured event-attributed configuration data as nodes distributed in a plurality of levels and the event-attributed configuration data comprise truncated configurations aggregated as data slices at one or more levels.

Example 44. The computer-implemented method of any of the preceding examples, wherein the noise comprises Laplace noise added to each of the data slices.

Example 45. The computer-implemented method of any of the preceding examples, comprising: generating weighted averages of parents and children to minimize a variance of an estimate of a parent node.

Example 46. The computer-implemented method of any of the preceding examples, wherein processing the raw aggregated summary reports to reduce the noise comprises: applying a denoising transformation to correct both for randomized response noising implemented by the Laplace noise and the truncated configurations.

Example 47. The computer-implemented method of any of the preceding examples, wherein the denoising transformation uses a set of summary statistics that index aspects of the configuration type.

Example 48. The computer-implemented method of any of the preceding examples, wherein the aggregated summary reports comprise metadata corresponding to a configuration type applied to the structured event-attributed configuration data.

Example 49. The computer-implemented method of any of the preceding examples, wherein the configuration parameters comprise a configuration count of each configuration type and a configuration window.

Example 50. The computer-implemented method of any of the preceding examples, further comprising: determining truncated averages as an expected total configuration count of the each configuration type and window when being truncated for configurations.

Example 51. The computer-implemented method of any of the preceding examples, determining truncated averages comprises: determining total truncated averages by aligning an aggregate configuration count with the application programming interface data; and determining sliced truncated averages by aligning a total aggregate configuration count with the application programming interface data.

Example 52. The computer-implemented method of any of the preceding examples, wherein the total truncated averages comprise a total configuration count truncated at a number of configurations.

Example 53. The computer-implemented method of any of the preceding examples, wherein the total truncated averages comprise corner cases.

Example 54. The computer-implemented method of any of the preceding examples, wherein the sliced truncated averages comprise truncation ratios per data slice.

Example 55. The computer-implemented method of any of the preceding examples, wherein estimating the probability of each of the branches to be true or noised comprises generating a ratio of total interactions count on an impression date obtained from interaction logs relative to total number of conditioning interactions.

Example 56. A computer-implemented system comprising: memory storing application programming interface (API) information; and a server performing operations comprising: receiving, from application programming interfaces, event level reports comprising a biased record of events comprising interactions with the application programming interfaces, the event level reports being paired with metadata corresponding to configurations applied by application programming interfaces; generating raw event level reports from the event level reports by applying a debiasing model using configuration parameters of the application programming interfaces to remove false events from the event level reports; receiving, from the application programming interfaces, aggregated summary reports comprising an aggregated record of the events corresponding to the interactions with the application programming interfaces included in the event level reports; generating raw aggregated summary reports from the aggregated summary reports by using metadata mapping to remove false positives events from the event level reports; generating statistical data by matching the raw event level reports to the raw aggregated summary reports according to event scenarios; determining operations using the statistical data; and providing, to an asset provider system, an instruction to activate at least one of the operations using the statistical data.

Example 57. The computer-implemented system of the preceding example, wherein the biased record of events comprises anonymization, aggregation, information truncation and noise infusion to interaction data to protect a privacy of users performing the interactions with the application programming interfaces, wherein the aggregated summary reports comprise hierarchically structured event-attributed configuration data as nodes distributed in a plurality of levels and the event-attributed configuration data comprise truncated configurations aggregated as data slices at one or more levels, wherein the noise comprises Laplace noise added to each of the data slices.

Example 58. The computer-implemented system of any of the preceding examples, wherein the aggregated summary reports comprise metadata corresponding to a configuration type applied to the structured event-attributed configuration data, and wherein the configuration parameters comprise a configuration count of each configuration type and a configuration window.

Example 59. A non-transitory computer-readable media encoded with a computer program, the computer program comprising instructions that when executed by one or more computers cause the one or more computers to perform operations comprising: receiving, from application programming interfaces, event level reports comprising a biased record of events comprising interactions with the application programming interfaces, the event level reports being paired with metadata corresponding to configurations applied by application programming interfaces; generating raw event level reports from the event level reports by applying a debiasing model using configuration parameters of the application programming interfaces to remove false events from the event level reports; receiving, from the application programming interfaces, aggregated summary reports comprising an aggregated record of the events corresponding to the interactions with the application programming interfaces included in the event level reports; generating raw aggregated summary reports from the aggregated summary reports by using metadata mapping to remove false positives events from the event level reports; generating statistical data by matching the raw event level reports to the raw aggregated summary reports according to event scenarios; determining operations using the statistical data; and providing, to an asset provider system, an instruction to activate at least one of the operations using the statistical data.

Example 60. The non-transitory computer-readable media of the preceding example, wherein the biased record of events comprises anonymization, aggregation, information truncation and noise infusion to interaction data to protect a privacy of users performing the interactions with the application programming interfaces, wherein the aggregated summary reports comprise hierarchically structured event-attributed configuration data as nodes distributed in a plurality of levels and the event-attributed configuration data comprise truncated configurations aggregated as data slices at one or more levels, wherein the noise comprises Laplace noise added to each of the data slices.

What is claimed is:

1. A computer-implemented method comprising:
receiving, from application programming interfaces, aggregated summary reports comprising aggregated event-data collected, by the application programming interfaces, during events corresponding to interactions with user interfaces, the aggregated event-data being aggregated using a hierarchical structure corresponding to a data type;
removing a first portion of the aggregated event data identified as false positives from the aggregated summary reports to maintain true positive aggregated event data;
reducing noise from the true positive aggregated event data, at each level of the hierarchical structure, to generate denoised aggregated summary reports;
determining operations using the denoised aggregated summary reports; and
providing, to an asset provider system, an instruction to activate at least one of the operations using the denoised aggregated summary reports.

2. The computer-implemented method of claim 1, wherein the aggregated summary reports comprise hierarchically structured event-attributed configuration data as nodes distributed in a plurality of levels.

3. The computer-implemented method of claim 2, wherein the event-attributed configuration data comprise truncated aggregated as data slices at one or more levels.

4. The computer-implemented method of claim 3, wherein the noise comprises Laplace noise added to each of the data slices.

5. The computer-implemented method of claim 4, further comprising:
generating weighted averages of parent nodes and child nodes to minimize a variance of an estimate of a parent node.

6. The computer-implemented method of claim 5, wherein processing the aggregated summary reports to reduce the noise comprises:
applying a denoising transformation to correct both for randomized response noising implemented by the Laplace noise and the truncated data.

7. The computer-implemented method of claim 6, wherein applying the denoising transformation comprises using a set of summary statistics that index aspects of a configuration type.

8. The computer-implemented method of claim 7, wherein the aggregated summary reports comprise metadata corresponding to the configuration type applied to the structured event-attributed configuration data.

9.-20. (canceled)

21. A computer-implemented method comprising:
receiving, from application programming interfaces, event level reports comprising branches defining records of events comprising interactions with the application programming interfaces, the event level reports being paired with metadata corresponding to configurations of the application programming interfaces;
performing an identification of portions of the metadata comprising invalid metadata;
classifying a portion of the events as being on true branches by estimating a probability of each of the branches to be true or noised using the identification of the portions of the metadata that comprise the invalid metadata;
determining configuration parameters for the true branches, the configuration parameters comprising a number of configurations on average for each event;
generating raw application programming interface data by applying a debiasing model using the configuration parameters by joining a plurality of reporting windows and configuration types;
determining operations using the raw application programming interface data; and
providing, to an asset provider system, an instruction to activate at least one of the operations using the raw application programming interface data.

22. The computer-implemented method of claim 21, wherein the configuration parameters comprise a configuration count of each configuration type and a configuration window.

23. The computer-implemented method of claim 22, further comprising:
determining truncated averages as an expected total configuration count of the each configuration type and window when being truncated for each configuration type.

24. The computer-implemented method of claim 21, determining truncated averages comprises:
determining total truncated averages by aligning an aggregate configuration count with the application programming interface data using impression dates; and
determining sliced truncated averages by aligning a total aggregate configuration count with the application programming interface data using the impression dates and delay window levels.

25. The computer-implemented method of claim 24, wherein the total truncated averages comprise a total configuration count truncated at a number of configurations.

26. The computer-implemented method of claim 24, wherein the total truncated averages comprise corner cases that are absent from event simulations and appear in the total aggregate configuration count.

27. The computer-implemented method of claim 21, wherein the sliced truncated averages comprise truncation ratios per data slice.

28. The computer-implemented method of claim 21, wherein estimating the probability of each of the branches to be true or noised comprises generating a ratio of total interactions count on an impression date obtained from interaction logs relative to total number of conditioning interactions.

29.-40. (canceled)

41. A computer-implemented method comprising:
receiving, from application programming interfaces, event level reports comprising a biased record of events comprising interactions with the application programming interfaces, the event level reports being paired with metadata corresponding to configurations applied by application programming interfaces;
generating raw event level reports from the event level reports by applying a debiasing model using configuration parameters of the application programming interfaces to remove false events from the event level reports;
receiving, from the application programming interfaces, aggregated summary reports comprising an aggregated record of the events corresponding to the interactions with the application programming interfaces included in the event level reports;
generating raw aggregated summary reports from the aggregated summary reports by using metadata mapping to remove false positives events from the event level reports;
generating statistical data by matching the raw event level reports to the raw aggregated summary reports according to event scenarios;
determining operations using the statistical data; and
providing, to an asset provider system, an instruction to activate at least one of the operations using the statistical data.

42. The computer-implemented method of claim 41, wherein the biased record of events comprises anonymization, aggregation, information truncation and noise infusion to interaction data to protect a privacy of users performing the interactions with the application programming interfaces.

43. The computer-implemented method of claim 42, wherein the aggregated summary reports comprise hierarchically structured event-attributed configuration data as nodes distributed in a plurality of levels and the event-attributed configuration data comprise truncated configurations aggregated as data slices at one or more levels.

44. The computer-implemented method of claim 43, wherein the noise comprises Laplace noise added to each of the data slices.

45. The computer-implemented method of claim 44, further comprising:
generating weighted averages of parents and children to minimize a variance of an estimate of a parent node.

46. The computer-implemented method of claim 45, wherein processing the raw aggregated summary reports to reduce the noise comprises:
applying a denoising transformation to correct both for randomized response noising implemented by the Laplace noise and the truncated configurations.

47. The computer-implemented method of claim 46, wherein the denoising transformation uses a set of summary statistics that index aspects of the configuration type.

48. The computer-implemented method of claim 41, wherein the aggregated summary reports comprise metadata corresponding to a configuration type applied to the structured event-attributed configuration data.

49. The computer-implemented method of claim 41, wherein the configuration parameters comprise a configuration count of each configuration type and a configuration window.

50. The computer-implemented method of claim 49, further comprising:
determining truncated averages as an expected total configuration count of the each configuration type and window when being truncated for configurations.

51. The computer-implemented method of claim 41, determining truncated averages comprises:
determining total truncated averages by aligning an aggregate configuration count with the application programming interface data; and
determining sliced truncated averages by aligning a total aggregate configuration count with the application programming interface data.

52. The computer-implemented method of claim 51, wherein the total truncated averages comprise a total configuration count truncated at a number of configurations.

53.-60. (canceled)
